(19) United States
(12) Patent Application Publication
(10) Pub. No.: US 2011/0115774 A1
(43) Pub. Date: May 19, 2011

(54) DRIVING METHOD FOR DRIVING ELECTROPHORETIC APPARATUS, ELECTROPHORETIC DISPLAY APPARATUS, ELECTRONIC DEVICE, AND CONTROLLER

(75) Inventor: Katsunori YAMAZAKI, Matsumoto (JP)

(73) Assignee: SEIKO EPSON CORPORATION, Tokyo (JP)

(21) Appl. No.: 12/944,133

(22) Filed: Nov. 11, 2010

(30) Foreign Application Priority Data
Nov. 13, 2009 (JP) 2009-259845

(51) Int. Cl. G09G 5/00; G09G 3/34

(52) U.S. Cl. 345/211; 345/107

(57) ABSTRACT

A driving method for driving an electrophoretic display apparatus provided with a display unit, which is configured to include a pair of substrates having electrophoretic components interposed therebetween, pixels that are disposed in a line direction and in a row direction, pixel electrodes corresponding to the respective pixels, and an opposite electrode being opposite the pixel electrodes, includes a process which allows one of the pixel electrodes corresponding to a first pixel, and one of the pixel electrodes corresponding to a second pixel, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.

### BACKGROUND

1. Technical Field

The present invention relates to a driving method for driving an electrophoretic apparatus, an electrophoretic apparatus, and an electronic device.

2. Related Art

In a typical electrophoretic display apparatus functioning as one of applications of electrophoretic apparatuses, processing is performed so that, before writing a new display content thereonto, a display content being maintained as of then is erased, and as one of methods for the erasure, an erasing method, which allows individual pixel electrodes to be simultaneously supplied with a voltage causing the individual pixel electrodes to each display a background color (for example, a white color), has been disclosed (refer to JP-A-2005-148711).

However, for the erasing method disclosed in JP-A-2005-148711, a disadvantage in that, as a result, an immediately previous display image thinly remains, that is, a so-called incidental image occurs, has been known to those skilled in the art.

### SUMMARY

An advantage of some aspects of the invention is to provide a driving method for driving an electrophoretic apparatus, an electrophoretic apparatus and an electronic device, which enable erasing a display image, concurrently with suppressing occurrences of incidental images thereof.

A driving method for driving an electrophoretic apparatus, according to a first aspect of the invention, is a driving method for driving an electrophoretic display apparatus provided with a display unit, which is configured to include a pair of substrates having electrophoretic components interposed therebetween, pixels that are disposed in a line direction and in a row direction, pixel electrodes that are provided so as to correspond to the respective pixels, and an opposite electrode that is provided so as to be opposite the pixel electrodes, and the driving method for driving an electrophoretic display apparatus includes a process which, when erasing an image being displayed on the display unit, allows one of the pixel electrodes, which corresponds to a first pixel selected from among the pixels, and one of the pixel electrodes, which corresponds to a second pixel selected from among the pixels, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.

According to this aspect, providing an electric potential difference between the pixel electrode corresponding to the first pixel and the pixel electrode corresponding to the second pixel, the first pixel and the second pixel being located adjacent each other, enables causing an electric field between the first pixel and the second pixel, and thereby, enables erasing a display image, concurrently with suppressing occurrences of incidental images thereof.

Further, preferably, the driving method for driving an electrophoretic apparatus, according to the first aspect of the invention, further includes a first process of supplying a first voltage to the pixel electrode corresponding to the first pixel, and supplying a second voltage, which is different from the first voltage, to the pixel electrode corresponding to the second pixel, and a second process of supplying the second voltage to the pixel electrode corresponding to the first pixel, and supplying the first voltage to the pixel electrode corresponding to the second pixel.

According to this preferable aspect, interchanging a voltage supplied to the pixel electrode corresponding to the first pixel and a voltage supplied to the pixel electrode corresponding to the second pixel by each process allows causing an electric field between the pixel electrode corresponding to the first pixel and the pixel electrode corresponding to the second pixel, the direction of the electric field being inverted by each process, and thus, enables increasing of the effect of suppressing occurrences incidental images, as well as enables reduction of a response time of each pixel, so that the driving method for an electrophoretic apparatus, according to the first aspect of the invention, is a superior driving method for driving an electrophoretic apparatus in an electric power saving operation.

Further, preferably, the first pixel is a pixel belonging to an odd numbered line of the pixels, and the second pixel is a pixel belonging to an even numbered line of the pixels.

According to this preferable aspect, it is possible to generate an electric potential difference between the pixel electrodes that are located adjacent each other in the line direction. As a result, it is possible to erase an image, concurrently with suppressing occurrences of incidental images thereof in the line direction.

Further, preferably, the first pixel is a pixel belonging to an odd numbered row of the pixels, and the second pixel is a pixel belonging to an even numbered row of the pixels.

According to this preferable aspect, it is possible to generate an electric potential difference between the pixel electrodes that are located adjacent each other in the row direction. As a result, it is possible to erase an image, concurrently with suppressing occurrences of incidental images thereof in the row direction.

Further, preferably, in each of the first process and the second process, all of the pixel electrodes belonging to a line of the pixels are supplied with either of the first voltage or the second voltage.

According to this preferable aspect, it is possible to select all the pixels included in a line of the pixels, and thus, it is possible to reduce a processing time necessary to perform image erasing processing to a great extent. As a result, the driving method for an electrophoretic apparatus, according to the first aspect of the invention is a superior driving method for an electrophoretic apparatus in an electric power saving operation.

Further, preferably, in each of the first process and the second process, all of the pixel electrodes belonging to a row of the pixels are supplied with either of the first voltage or the second voltage.

According to this preferable aspect, it is possible to select all the pixels included in a row of the pixels, and thus, it is possible to reduce a processing time necessary to perform image erasing processing to a great extent. As a result, the driving method for an electrophoretic apparatus, according to the first aspect of the invention, is a superior driving method for an electrophoretic apparatus in an electric power saving operation.

Further, preferably, a plurality of the first pixels include a pixel selected from among the pixels corresponding to respective intersections of odd numbered lines of the pixels and odd numbered rows of the pixels, and a pixel selected from among the pixels corresponding to respective intersections of even numbered lines of the pixels and even numbered rows of the pixels, and a plurality of the second pixels include a pixel selected from among the pixels corresponding to respective intersections of odd numbered lines of the pixels and even numbered rows of the pixels, and a pixel selected from among the pixels corresponding to respective intersections of even numbered lines of the pixels and odd numbered rows of the pixels.

According to this preferable aspect, the first pixel and the second pixel are arrayed in a checkered pattern, and by supplying voltages, which are different from each other, to the respective two pixels, which are located adjacent each other in the upper and lower direction or in the right and left direction, electric fields occur in the directions away from and towards the respective four sides of each of the pixels, and thus, it is possible to suppress occurrences of incidental images at the boundaries of individual pixels to a more extent.

Further, preferably, a plurality of the first pixels form a group of the first pixels that correspond to respective intersections of any two adjacent lines selected from among the lines of the pixels, and any one row selected from among the rows of the pixels, and a plurality of the second pixels form a group of the second pixels that correspond to respective intersections of any two adjacent lines selected from among the lines of the pixels and any one row selected from among the rows of the pixels, the group of the second pixels being located adjacent to the group of the first pixels in the line direction, and further, being located adjacent to the group of the first pixels in the row direction.

According to this preferable aspect, for each unit of handling pixels, which consists of two pixels corresponding to the respective intersections of two adjacent lines, and is allocated in a checkered pattern, image reset processing is performed. Since just supplying the same voltage pattern to two groups of pixels, corresponding to the respective two successive lines, is necessary, it is easier to perform control of the driving method than before, and further, it is possible to reduce power consumption.

Further, preferably, a series of the first process and the second process are iteratively performed at a plurality of times.

According to this preferable aspect, by performing a series of the first process and the second process iteratively at a plurality of times, it is possible to perform reset processing on all the pixels included in the display unit with certainty.

An electrophoretic apparatus according to a second aspect of the invention is an electrophoretic apparatus provided with a display unit, which is configured to include a pair of substrates having electrophoretic components interposed therebetween, pixels that are disposed in a line direction and in a row direction, pixel electrodes that are provided so as to correspond to the respective pixels, and an opposite electrode that is provided so as to be opposite the pixel electrodes, and the electrophoretic apparatus includes a control unit configured to, when erasing an image being displayed on the display unit, allows one of the pixel electrodes, which corresponds to a first pixel selected from among the pixels, and one of the pixel electrodes, which corresponds to a second pixel selected from among the pixels, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.

According to this aspect, providing an electric potential difference between the pixel electrode corresponding to the first pixel and the pixel electrode corresponding to the second pixel, the first pixel and the second pixel being located adjacent each other, enables causing an electric field between the first pixel and the second pixel, and thereby, enables erasing a display image, concurrently with suppressing occurrences of incidental images thereof.

An electronic device according to a third aspect of the invention includes the electrophoretic apparatus according to the second aspect of the invention.

An electronic device according to this aspect results in an electronic device provided with a display method, in which a function of erasing an image without causing an incidental image thereof and a function of displaying a high-quality image having no lack of display uniformity are included.

### BRIEF DESCRIPTION OF THE DRAWINGS

The invention will be described with reference to the accompanying drawings, wherein like numbers reference like elements.

FIG. 1 is a diagram illustrating an outline of a configuration of an electrophoretic display apparatus according to a first embodiment of the invention.

FIG. 2 is a block diagram illustrating a circuit of a display system of an electrophoretic display apparatus according to a first embodiment of the invention.

FIG. 3 is a diagram illustrating a structure of pixels included in an electrophoretic display apparatus according to a first embodiment of the invention.

FIGS. 4A and 4B are diagrams each illustrating a structure of a pixel according to a first embodiment of the invention.

FIGS. 5A and 5B are diagrams used for explanation of an electrophoretic component according to a first embodiment of the invention.

FIG. 6 is a timing chart illustrating a driving method for driving an electrophoretic display apparatus, according to a first embodiment of the invention.

FIGS. 7A, 7B and 7C are diagrams illustrating condition changes of two pixels targeted for explanation of a driving method for driving an electrophoretic display apparatus, according to a first embodiment of the invention.

FIGS. 8A, 8B and 8C are diagrams illustrating condition changes of pixels included in a driving method for driving an electrophoretic display apparatus, according to a first embodiment of the invention.

FIG. 9 is a timing chart illustrating a driving method for driving an electrophoretic display apparatus, according to a second embodiment of the invention.

FIGS. 10A and 10B are diagrams illustrating condition changes of pixels targeted for explanation of a driving method according to a second embodiment of the invention.

FIG. 11 is a timing chart illustrating a driving method for driving an electrophoretic display apparatus, according to a third embodiment of the invention.

FIGS. 12A and 12B are diagrams illustrating condition changes of pixels targeted for explanation of a driving method according to a third embodiment of the invention.

FIG. 13 is a timing chart illustrating a driving method for driving an electrophoretic display apparatus, according to a fourth embodiment of the invention.

FIG. 14 is a timing chart illustrating a driving method for driving an electrophoretic display apparatus, according to a fifth embodiment of the invention.

FIG. 15 is a timing chart illustrating a driving method for driving an electrophoretic display apparatus, according to a sixth embodiment of the invention.

FIG. 16 is a timing chart illustrating a driving method for driving an electrophoretic display apparatus, according to a seventh embodiment of the invention.

FIGS. 17A and 17B are diagrams illustrating condition changes of pixels targeted for explanation of a driving method according to a seventh embodiment of the invention.

FIG. 18 is a timing chart illustrating a driving method for driving an electrophoretic display apparatus, according to an eighth embodiment of the invention.

FIGS. 19A and 19B are diagrams illustrating condition changes of pixels targeted for explanation of a driving method according to an eighth embodiment of the invention.

FIG. 20 is a diagram illustrating an example of an electronic device according to an embodiment of the invention.

FIG. 21 is a diagram illustrating an example of an electronic device according to an embodiment of the invention.

FIG. 22 is a diagram illustrating an example of an electronic device according to an embodiment of the invention.

### DESCRIPTION OF EXEMPLARY EMBODIMENTS

Hereinafter, embodiments according to the invention will be described with reference to drawings.

In addition, the scope of the invention is not limited to the following embodiments but can be arbitrarily modified within the scope of technical thoughts of the invention. Further, in the following drawings, in order to allow configurations shown therein to be easily understood, scales, numerical quantities and the like of individual structures shown therein are sometimes illustrated so as to be different from actual scales, numerical quantities and the like thereof.

### First Embodiment

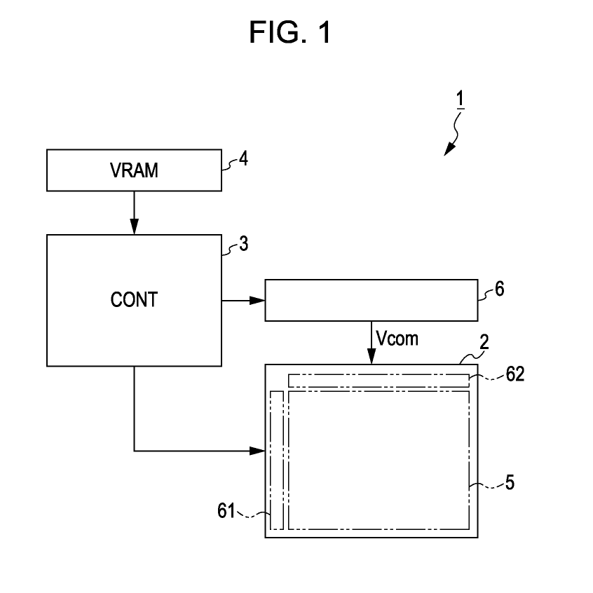

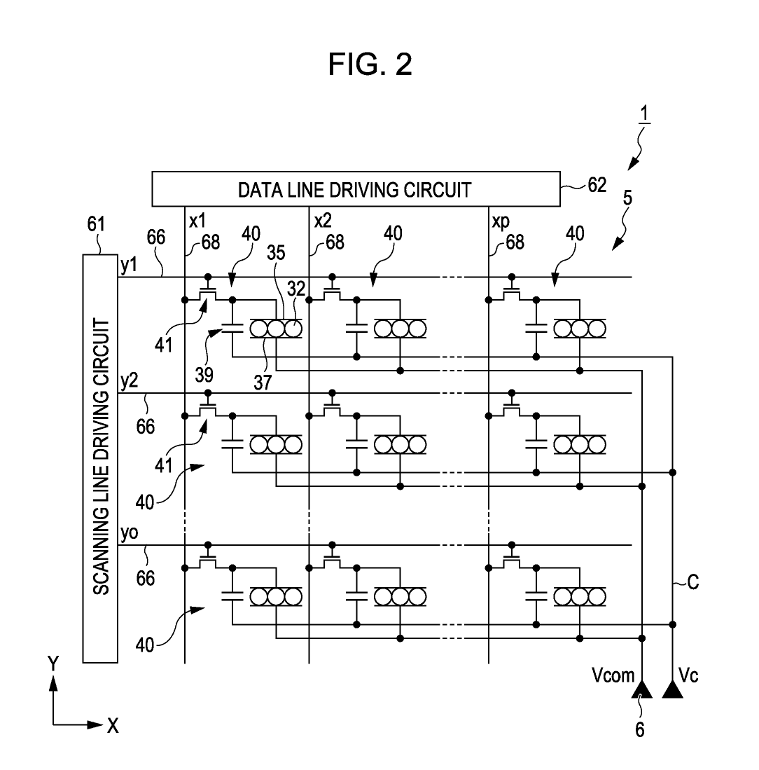

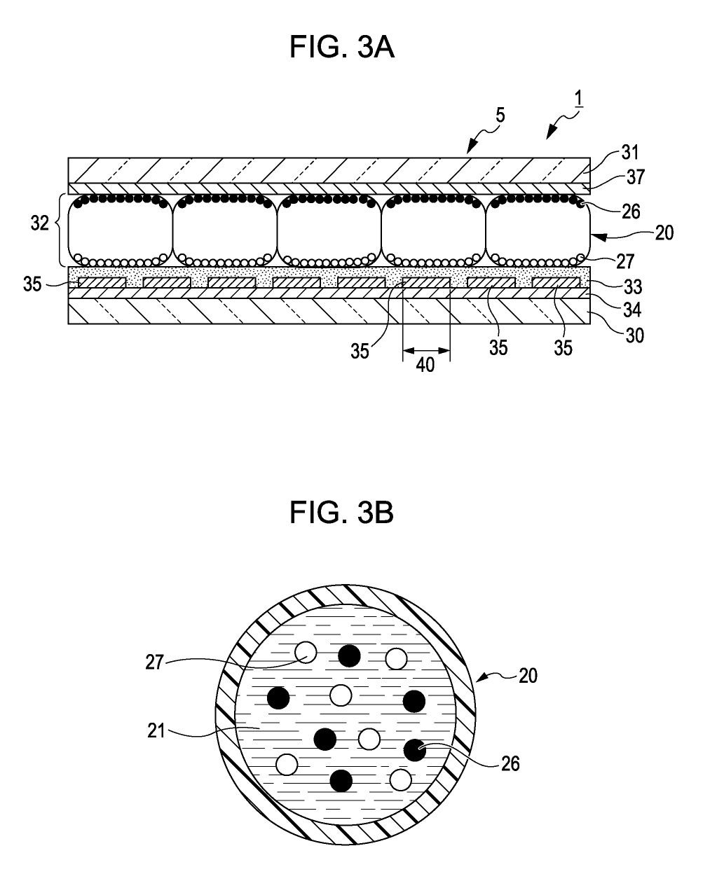

FIG. 1 is a diagram illustrating an outline of a configuration of an electrophoretic display apparatus, which is an embodiment of an electrophoretic apparatus according to the invention. FIG. 2 is a block diagram illustrating a circuit of a display system of an electrophoretic display apparatus according to this embodiment. FIG. 3 is a diagram illustrating a structure of pixels included in an electrophoretic display apparatus according to this embodiment.

An electrophoretic display apparatus (an electrophoretic apparatus) 1 shown in FIG. 1 is configured to included a display system 2, a controller 3, a video random access memory (VRAM) 4 and a common electrode driving circuit 6. The display system 2 is configured to receive control signals from the controller 3 and be supplied with a voltage from the common electrode driving circuit 6, and thereby, display images thereon. The display system 2 is configured to included a display unit 5, a scanning line driving circuit 61 and a data line driving circuit 62 formed therein.

The controller 3 is a control unit of the electrophoretic display apparatus 1, which is configured to receive image data to be displayed from the VRAM 4 and perform control so as to cause the display system 2 to display images on the basis of the received image data. More specifically, the controller 3 is configured to perform control so as to cause the scanning line driving circuit 61 and the data line driving circuit 62, which are included in the display system 2, and the common electrode driving circuit 6 to display images. The control signals outputted from the controller 3 are, for example, timing signals, such as clock signals and start pulses, image data, power supply voltages and the like.

The VRAM 4 is used to, from image data stored in a storage unit (omitted from illustration), such as a flush memory unit, read out and temporarily store therein a screen of image data or a plurality of screens of image data to be subsequently displayed on the display unit 5.

The common electrode driving circuit 6 is configured to be connected to a common electrode 37 (an opposite electrode; refer to FIGS. 2 and 3) included in the display system 2, and supply the common electrode 37 with a common electrode electric potential Vcom having an arbitrarily determined electric potential level.

As shown in FIG. 2, the display unit 5 of the display system 2 is configured to form a plurality of scanning lines 66 (y1, y2, . . . , yo) each extending in a X-axis direction and a plurality of data lines 68 (x1, x2, . . . , xp) each extending in a Y-axis direction. Pixels 40 are formed so as to correspond to the respective intersection points of the scanning lines 66 and the data lines 68, and are connected to the corresponding scanning lines 66 and data lines 68. The pixels 40 are aligned in a matrix consisting of o lines along the Y-axis and p rows along the X-axis. Further, the display unit 5 is configured to form a common electrode 37 connected to the common electrode driving circuit 6.

In the electrophoretic display apparatus 1 according to this embodiment, it is possible to arbitrarily set the number of the scanning lines 66 and the number of the data lines 68.

The pixels 40 are each configured to form therein a selection transistor 41 functioning as a pixel switching component, a storage capacitor 39, a common electrode 37, and an electrophoretic component 32 (an electro-optic layer).

The selection transistor 41 is configured by a negative metal oxide semiconductor (N-MOS) TFT. The selection transistor 41 has a gate that is connected to one of the scanning lines 66, a source that is connected to one of the data lines 68, and a drain that is connected to one of the electrodes of the storage capacitor 39 and the pixel electrode 35.

The storage capacitor 39 is formed on a component substrate, which will be described below, and is formed of a pair of electrodes that are allocated so as to be opposite each other and interpose a dielectric film therebetween. One electrode of the storage capacitor 39 is connected to the selection transistor 41 and the other electrode thereof is connected to a capacitor line C. The storage capacitor 39 is charged by an image-signal voltage that is written thereinto via the selection transistor 41.

The electrophoretic component 32 is configured by a plurality of microcapsules each being configured to include electrophoretic particles therein.

The scanning line driving circuit 61 shown in FIG. 2 is connected to the scanning lines 66 that are formed in the display unit 5, and via the individual scanning lines 66, the scanning line driving circuit 61 is connected to groups of the pixels 40, which correspond to the respective lines of the scanning lines 66.

The scanning line driving circuit 61 sequentially supplies the individual scanning lines 66 (y1, y2, . . . , yo) with pulse-shaped selection signals on the basis of timing signals supplied from the controller 3, and thereby, sequentially and exclusively causes each of the scanning lines 66 to be in a selected condition. The selected condition is a condition in which the selection transistors 41 connected to one of the scanning lines 66 is turned on. Here, a scanning signal corresponding to a selected scanning line 66 is called a selection voltage (Vsel), which is equivalent to a high-level voltage that is maintained to be high level during a horizontal scanning period of time, and a scanning signal corresponding to each of the scanning lines 66 other than the selected scanning line 66 is called a non-selection voltage (Vnon_sel), which is equivalent to a low-level voltage.

The common electrode 37 is supplied with a common electrode electric potential Vcom from the common electrode driving circuit 6. The common electrode driving circuit 6 is configured so as to be capable of generating an electric potential having an arbitrarily determined waveform. The common electrode electric potential Vcom may be configured to be an electric potential that is maintained to be a constant electric potential (for example, a ground electric potential), or may be configured to cause a plurality of electric potentials (for example, a low-level electric potential VL and a high-level electric potential VH) to be inputted thereto.

The data line driving circuit 62 is connected to the data lines 68 that is formed in the display unit 5, and via the individual data lines 68, the data line driving circuit 62 is connected to groups of the pixels 40, which correspond the respect rows of the pixels 40.

The data line driving circuit 62 sequentially supplies the individual data lines 68 (x1, x2, . . . , xo) with data signals on the basis of timing signals supplied from the controller 3.

In this embodiment, the pixels 40 to be displayed in a black color are supplied with a negative voltage Vb (for example, −15V) relative to the common electrode electric potential Vcom, and the pixels 40 to be displayed in a white color are supplied with a positive voltage Vw (for example, +15V) relative to the common electrode electric potential Vcom.

The storage capacitor line C is supplied with a storage capacitor line electric potential Vc from a driving circuit (omitted from illustration). With respect to the driving circuit for driving the storage capacitor line C, a dedicated circuit may be provided, or either the scanning line driving circuit 61 or the common electrode driving circuit 6 may be configured to concurrently function as the driving circuit for driving the storage capacitor line C.

The pixel 40 is configured to include the selection transistor 41, the pixel electrode 35, the electrophoretic component (electro-optic component) 32 and the common electrode 37. Further, to the pixel 40, the scanning line 66, the data line 68 and the capacitor line C are connected. The selection transistor 41 is a negative metal oxide semiconductor (N-MOS) transistor.

In addition, the selection transistor 41 may be replaced by a different type switching transistor having a function equivalent to that of the N-MOS transistor. For example, as a substitute for the N-MOS transistor, a P-MOS transistor may be used, and further, an inverter or a transmission gate may be used.

The selection transistor 41 has a gate that is connected to the scanning line 66, a source that is connected to the data line 68, and a drain that is connected to the image electrode 35. The electrophoretic 32 is interposed between the image electrode 35 and the common electrode 37.

Next, FIG. 3A is a diagram illustrating a partial cross-section of the electrophoretic display apparatus 1 included in the display unit 5. The electrophoretic apparatus 1 is configured to interpose the electrophoretic component 32, in which a plurality of the microcapsules 20 are disposed, between the component substrate 30 and the opposite substrate 31.

In the display unit 5, at the electrophoretic component 32 side of the component substrate 30, a circuit layer 34, in which the scanning lines 66, the data lines 68, the selection transistors 41 and the like are formed, is provided, and on the circuit layer 34, a plurality of the pixel electrodes 35 are formed so as to be disposed.

The component substrate 30 is a substrate that is made of a glass material, a plastic material or the like. Further, the component substrate 30 is allocated at the opposite side of an image display surface, and thus, may not be transparent. The pixel electrode 35 is an electrode configured to, on a copper (Cu) thin film, laminate a nickel plating layer and a gold plating layer in the above-described order, and apply a voltage to the electrophoretic component 32 that is formed of aluminum (Al), indium tin oxide (ITO) and the like.

Further thereto, at the electrophoretic component 32 side of the opposite substrate 31, the plane-shaped common electrode 37 is formed so as to be opposite the plurality of the pixel electrodes 35, and on the common electrode 37, the electrophoretic component 32 is provided.

The opposite substrate 31 is a substrate that is made of a glass material, a plastic material or the like. Further, the opposite substrate 31 is allocated at the image display side, and thus, is configured to be a transparent substrate. The common electrode 37 is an electrode applying a voltage to the electrophoretic component 32, as well as to the pixel electrode 35, and is a transparent electrode that is formed of magnesium silver (MgAg), indium tin oxide (ITO), indium zinc oxide (IZO) and the like.

Further, by bonding the electrophoretic component 32 and the pixel electrodes 35 via an adhesion bond layer 33, the component substrate 30 and the opposite substrate 31 are jointed to each other.

FIG. 3B is a pattern cross-sectional view of the microcapsule 20. The microcapsule 20 has a participle diameter of, for example, approximately 50 μm, and has a globular body, inside which a disperse medium 21, a plurality of white-color participles (electrophoretic participles) 27, a plurality of black-color participles (electrophoretic participles) 26 are encapsulated. As shown in FIG. 3A, the microcapsule 20 is interposed between the common electrode 37 and the pixel electrode 35, and within one of the pixels 40, one or more microcapsules 20 are allocated.

The outer shell portion (membrane) of the microcapsule 20 is made of a polymeric resin having translucency, which is, for example, an arylate resin such as polymethylmethacrylate and polyethylmethacrylate, a urea resin, a gum arabic, gelatin, or the like.

The dispersion medium 21 is a liquid which disperses the white-color particles 27 and the black-color particles 26 inside the microcapsule 20. The dispersion medium 21 may be, for example, water, an alcohol solvent (methanol, ethanol, isopropanol, butanol, octanol, methyl cellusolve and the like), an ester solvent (ethyl acetate, butyl acetate and the like), a ketone group (acetone, methyl ethyl ketone, methyl isobutyl ketone and the like), an aliphatic hydrocarbon (pentane, hexane, octane and the like), an alicyclic hydrocarbon (cyclohexane, methyl cyclohexane and the like), an aromatic hydrocarbon (benzene, toluene, and a benzene series having a long-chain alkyl base (xylene, hexyl benzene, heptyl benzene, octyl benzene, nonyl benzene, decyl benzene, undecylic benzene, dodecyl benzene, tridecyl benzene and tetradecyl benzene)), a halogenated hydrocarbon (methylene chloride, chloroform, carbon tetrachloride, 1,2 dichloroethane and the like), a carboxylate salt and the like, and further, may be other types of oils. Any one of these materials can be used singly or in a mixture with any others of these materials. Further, the dispersion medium 21 may be combined with an interfacial active agent.

Each of the white-color particles 27 is a particle (a polymer molecule or a colloid) made of a white color pigment, such as titanium dioxide, a Chinese white (a zinc oxide) or an antimony trioxide, and further, is used being, for example, negatively charged. Each of the black-color particles 26 is a particle (a polymer molecule or a colloid) made of a black color pigment, such as an aniline black or a carbon black, and further, is used being, for example, positively charged.

To these pigments, when necessary, a charging control material composed of particles such as electrolytes, interfacial active agents, metal soaps, resins, gum, oil, varnish and compounds, dispersants such as titanium coupling agents, aluminum coupling agents and silane coupling agents, lubricant agents, stabilization agents and the like, can be added.

Additionally, as substitutes for the white-color particles 27 and the black-color particles 26, any two ones of pigments each having a red color, a green color, a blue color and the like may be used. Such a configuration enables display of any two ones of the red color, the green color, the blue color and the like.

In addition, a material, in which unicolor particles are dispersed in the colored disperse medium 21, may be used.

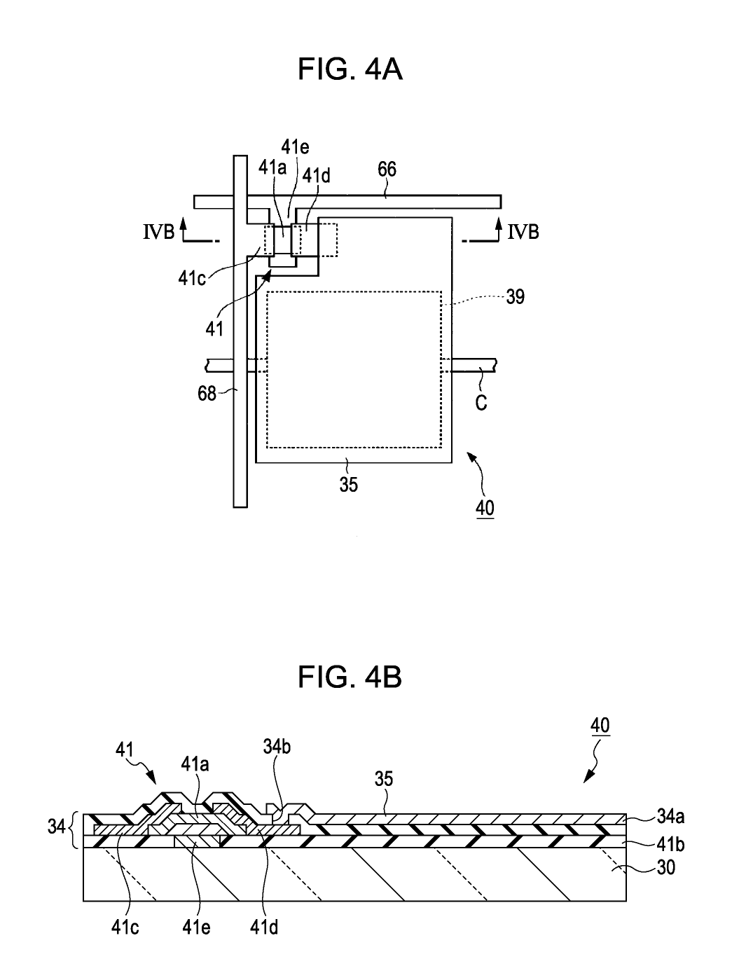

Here, FIG. 4A is a plan view of the component substrate 30 with respect to one of the pixels 40, and FIG. 4B is a cross-sectional view taken along the line A-A′ of FIG. 4A.

As shown in FIG. 4A, the selection transistor 41 is configured to include a semiconductor layer 41a having an approximately rectangular shape when seen from a plan view, a source electrode 41c extending from the data line 68, a drain electrode 41d connecting the semiconductor layer 41a to the pixel electrode 35, and a gate electrode 41e extending from the scanning line 66. The storage capacitor 39 is formed around a portion where the pixel electrode 35 and the storage capacitor line C are overlapped each other when seen from a plan view.

According to a cross-section structure shown in FIG. 4B, the gate electrode 41e (the scanning line 66), which is made of an aluminum material or an aluminum base alloy material, is formed on the component substrate 30, and a gate insulating film 41b, which is made of a silicon oxide material or a silicon nitride material, is formed so as to cover the gate electrode 41e. The semiconductor layer 41a, which is made of an amorphous silicon material or a polysilicon material, is formed at a portion opposing the gate electrode 41e via the gate insulating film 41b. The source electrode 41c and the drain electrode 41d, each of which is made of an aluminum material or an aluminum base alloy material, are each formed so as to be partially mounted on the semiconductor layer 41a. An inter-layer insulating film 34a, which is made of a silicon oxide material or a silicon nitride material, is formed so as to cover the source electrode 41c (the data line 68), the drain electrode 41d, the semiconductor layer 41a and the gate insulating film 41b. The pixel electrode 35 is formed on the inter-layer insulating film 34a. The pixel electrode 35 and the drain electrode 41d are connected to each other via a contact hole 34b, which is formed so as to pass through the inter-layer insulating film 34a and reach the drain electrode 41d.

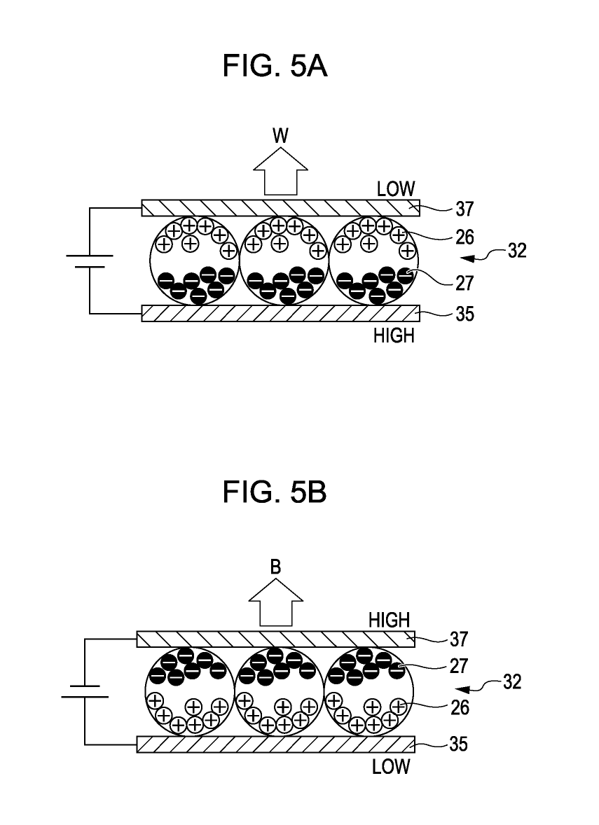

FIG. 5A and FIG. 5B are diagrams used for explanation of an electrophoretic component. FIG. 5A shows a case in which each of the pixels 40 is caused to display a white color, and FIG. 5B shows a case in which each of the pixels 40 is caused to display a black color. In order to cause a pixel to display a white color, such as shown in FIG. 5A, the common electrode 37 is maintained to be at a relatively low electric potential level, and the pixel electrode 35 is maintained to be at a relatively high electric potential level. Owing to this operation, the positively charged white-color particles 27 are attracted towards the common electrode 37, whereas the negatively charged black-color particles 26 are attracted towards the pixel electrode 35. As a result, when such a pixel is seen from the common electrode 37 side, i.e., from the display surface side, a while color (W) can be perceived.

In order to cause a pixel to display a black color, such as shown in FIG. 5B, the common electrode 37 is maintained to be at a relatively high electric potential level, and the pixel electrode 35 is maintained to be at a relatively low electric potential level. Owing to this operation, the negatively charged black-color particles 26 are attracted towards the common electrode 37, whereas the positively charged white-color particles 27 are attracted towards the pixel electrode 35. As a result, when such a pixel is seen from the common electrode 37 side, a black color (B) can be perceived.

### Driving Method

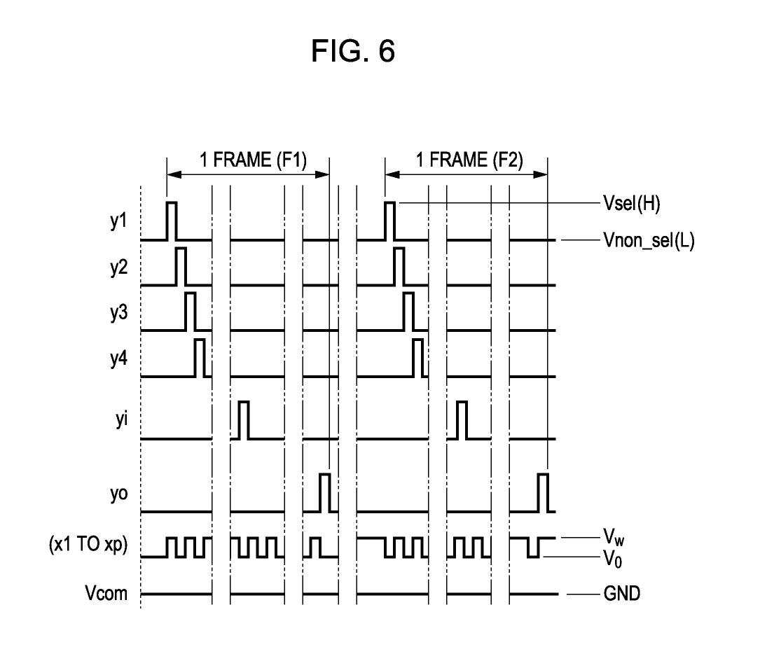

Next, a driving method for driving an electrophoretic display apparatus, according to this embodiment, will be described below with reference to FIG. 6.

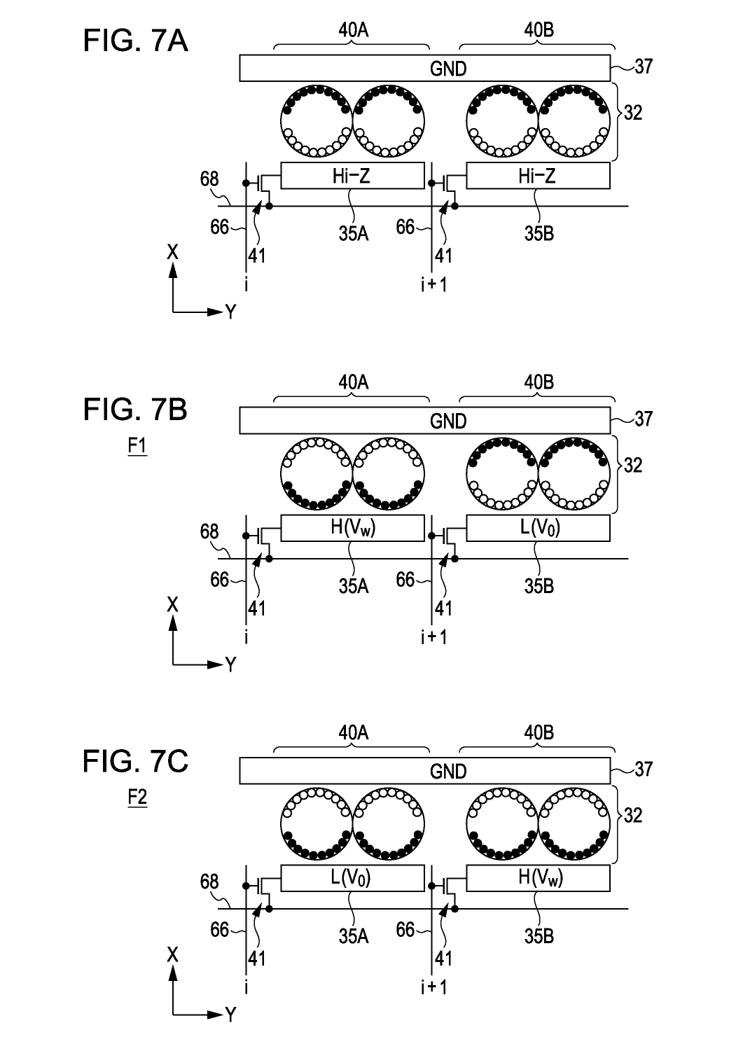

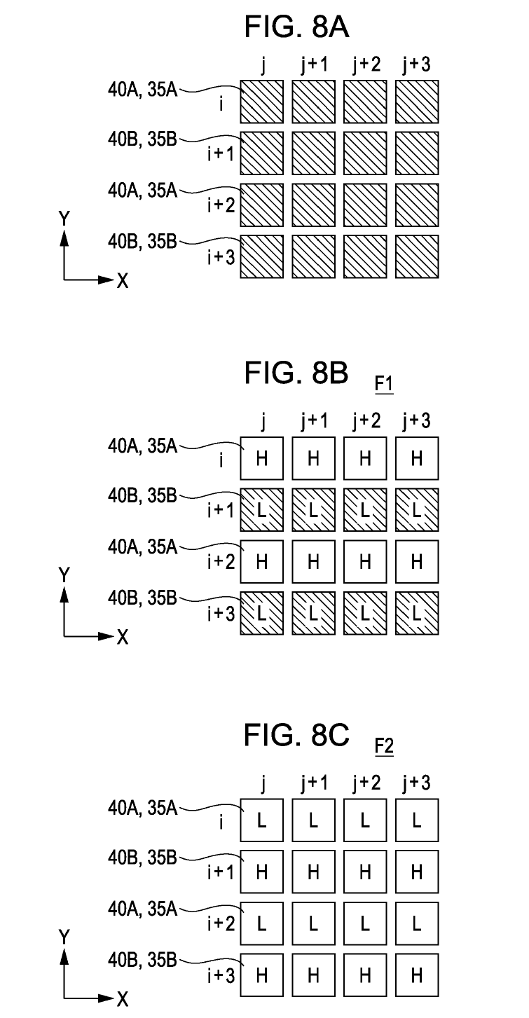

FIG. 6 is a timing chart illustrating a driving method for driving the electrophoretic display apparatus 1. FIG. 6 shows electric potential changes of the individual scanning lines 66 (y1, y2, . . . , yo) and data lines 68 (x1, x2, . . . , xp), the scanning lines 66 and the data lines 68 being included in the display unit 5 of the electrophoretic display apparatus 1, during an image erasing period of time while a black display image being displayed on the display unit 5 is erased. Further, FIGS. 7A, 7B and 7C are diagrams illustrating conditions of two pixels targeted for explanation of a driving method according to the first embodiment. Further, FIGS. 8A, 8B and 8C are diagrams illustrating condition changes of pixels in a driving method according to the first embodiment. In addition, two pixels shown in each of FIGS. 7A, 7B and 7C correspond to respective two pixels that are located adjacent each other in a Y-axis direction (i.e., in a line direction), such as shown in each of FIGS. 8A, 8B and 8C.

It is assumed that, before performing image erasing processing, the display unit 5 is in a condition in which a certain black display image is displayed thereon, and furthermore, in this embodiment, for simplification of the following explanation, it is assumed that, before performing image erasing processing, the pixels 40 targeted for explanation are each displayed in a black color. In each of FIG. 7A and FIG. 8A, a plurality of the pixels 40, each being displayed in a black color, are shown. In this case, each of the pixel electrodes 35 and the common electrode 37 are in a high impedance condition (Hi-Z), that is, in an electrically insulated condition (refer to FIG. 7A).

It is assumed that, in the image erasing processing, white erasing processing is performed, and write processing on each of the pixels 40 corresponding to the respective intersections of a pair of a first line and a second line of the scanning lines 66, which are located adjacent each other, and a pair of a first row and a second row of the data lines 68, which are located adjacent each other, will be described below. More specifically, write processing on each of the pixels 40 corresponding to the respective intersections of a pair of an odd numbered line (for example, an i-th line) of the scanning lines 66 and an even numbered line (for example, an (i+1)th line) of the scanning lines 66, and a pair of an odd numbered row (for example, a j-th row) of the data lines 68 and an even numbered row (for example, a (j+1)th row) of the data lines 68, will be described below focusing on relations between timings of individual scanning signals and respective voltages of the data lines 68. Here, the above-described “i” and “j” satisfy the following formulae, 1≦i≦o and 1≦j≦p, respectively.

Regarding the image erasing processing, firstly, as shown in FIG. 6, in a first frame (in a first vertical scanning period of time) F1, the scanning lines 66 are sequentially selected by the scanning line driving circuit 61 on a line-by-line basis, and a predetermined image signal is inputted each of the pixels 40 belonging to the selected scanning line 66. Here, a period of time, during which selections of all the scanning lines 66 have been completed, is equal to a period of time of one frame 1F. In this embodiment, from among the plurality of the scanning lines 66 y1 to yo, one scanning line is sequentially selected, and a selection voltage (Vsel) is supplied to the selected scanning line, and a non-selection voltage (Vnon_sel) is supplied to each of non-selected scanning lines 66. Here, the selection voltage (Vsel) is a high-level electric potential that causes each of the selection transistors 41 connected to the selected scanning line 66 to be in a turned-on condition, and the non-selection voltage (Vnon_sel) is an electric potential that causes each of the selection transistors 41 connected to the non-selected scanning line 66 to be in a turned-off condition. (For example, an electric potential level of the non-selection voltage (Vnon_sel) is −20 V relative to an electric potential level of the common electrode 37.) Further, a ground electric potential GND (0 V) is inputted to the common electrode 37 (whose electric potential is denoted by Vcom). Further, in synchronization with scanning of each of the scanning lines 66, a predetermined voltage is supplied to all the data lines 68.

In the first frame F1, in synchronization with sequential operations of selecting the scanning lines 66, performed by the scanning line driving circuit 61, for example, during a period of time while the selection voltage (Vsel) is supplied to each of odd numbered lines of the scanning lines 66 (y1, y3, . . . ), a first voltage (Vw), which has such a voltage level relative to a reference electric potential level, i.e., an electric potential level of the common electrode 37, that causes each of the pixels 40 belonging to the odd numbered line of the scanning lines 66 to display a white color, is supplied to all the data lines 68, and during a period of time while the selection voltage (Vsel) is supplied to each of even numbered lines of the scanning lines 66 (y2, y4, . . . ), a second voltage (Vo), which has a voltage level different from that of the first voltage (Vw), is supplied to all the data lines 68. Here, the first voltage (Vw) and the second voltage (Vo) each have a polarity the same as that of the electric potential of the common electrode 37 (i.e., the common electrode electric potential Vcom). The pulse width of each of rectangular pulses that are supplied to the respective data lines 68 in synchronization with the selection of a certain line of the scanning lines 66 is set in accordance with a duration in which the certain line of the scanning lines 66 is selected.

In this embodiment, as the first voltage (Vw), a high-level electric potential (for example, +15 V) is supplied to the pixel electrode 35A, and as the second voltage (Vo), a low-level electric potential (for example, 0 V) is supplied to the pixel electrode 35B. In addition, if any electric potential difference occurs between the pixel electrode 35A and the pixel electrode 35B, which correspond to a first pixel 40A and a second pixel 40B, respectively, the first pixel 40A and the second pixel 40B being located adjacent each other in the line direction, the second voltage (Vo) i.e., the low-level electric potential is not necessary to be equal to 0 V, but can be set to any electric potential level that causes the pixel electrode 35B to maintain a display condition thereof as it is, or display a white color. That is, the first voltage (Vw) and the second voltage (V0) each have a polarity (positive) the same as that of the common electrode electric potential Vcom (0 V). In addition, the “0 V” is regarded to be included in the polarity the same as that of the common electrode electric potential Vcom.

In such a way as described above, as a result, high-level (H) signals are inputted to the respective pixel electrodes 35A belonging to each of the odd numbered lines (i, i+2, . . . ) and low-level (L) signals, each causing a pixel electrode to maintain a display condition thereof as it is, are inputted to the respective pixel electrodes 35B belonging to each of the even numbered lines (i+1, i+3, . . . ) (refer to FIG. 8B).

Subsequently thereto, in the first frame F1, during a period of time while the common electrode 37 is in a low-level condition, the electrophoretic components 32 existing on the pixel electrode 35A are driven by an electric potential difference generated between the pixel electrode 35A (high level) and the common electrode 37. As a result of such an operation, as shown in FIG. 7B, the white-color participles 27 are attracted towards the common electrode 37 side, and the black-color participles 26 are attracted towards the pixel electrode 35A side, so that the first pixels 40A (corresponding to “a first pixel”) belonging to any one of the odd numbered lines (for example, an i-th line) each commence to display a white color. In this case, an electric potential difference, which occurs between the pixel electrode 35A belonging to any one of the odd numbered lines (for example, an i-th line) and the pixel electrode 35B belonging to any one of the even numbered lines (for example, an (i+1)th line), generates an electric field between the pixel electrode 35A and the pixel electrode 35B, which are located adjacent each other in the line direction, and as a result, allows particles existing at the boundary between the first pixel 40A and the second pixel 40B to move easily. The electric field, herein, is an electric field not extending in a vertical direction but extending in an oblique direction relative to the surfaces of the substrates, and the electric field in the oblique direction includes an electric field extending in parallel with the surfaces of the substrates, or a component thereof extending in parallel with the surfaces of the substrates, is included.

Upon termination of the first frame F1, as shown in FIG. 8B, the first pixels 40A belonging to each of the odd numbered lines (i, i+2, . . . ) each change a display condition thereof to a white display condition. Further, after the termination of the first frame F1, continuously or subsequent to elapse of a predetermined period of time, scanning operations in a subsequent frame are started.

As shown in FIG. 6, in a second frame F2, during a period of time while the selection voltage (Vsel) is supplied to each of the odd numbered lines of the scanning lines 66 (y1, y3, . . . ), the second voltage (V0) is supplied to all the data lines 68, and during a period of time while the selection voltage (Vsel) is supplied to each of the even numbered lines of the scanning lines 66 (y2, y4, . . . ), the first voltage (Vw) is supplied to all the data lines 68. In such a way as described above, as a result, the high-level (H) signals are inputted to the respective pixel electrodes 35A belonging to each of the even numbered lines (i+1, i+3, . . . ), and the low-level (L) signals are inputted to the respective pixel electrodes 35B belonging to each of the odd numbered lines (i, i+2, . . . ) (refer to FIG. 8C).

Further, in the second frame F2, the electrophoretic components 32 existing on the pixel electrode 35B are driven by an electric potential difference generated between the pixel electrode 35B and the common electrode 37. As a result of such an operation, as shown in FIG. 7C, the white-color particles 27 are attracted towards the common electrode 37 side, and the black-color particles 26 are attracted towards the pixel electrodes 35B side, so that the second pixels 40B belonging to each of the even numbered lines each commence to display a white color. In this case as well, an electric potential difference, which occurs between the pixel electrode 35A belonging to any one of the odd numbered lines and the pixel electrode 35B belonging to any one of the even numbered lines generates an electric fields between the pixel electrode 35A and the pixel electrode 35B, which are located adjacent each other in the line direction, and the second pixels 40B belonging to each of the even numbered lines each display a white color.

In such a way as described above, as shown in FIG. 8C, all the second pixels 40B belonging to each of the even numbered lines (i+1, i+3, . . . ) each change a display condition thereof to a white display condition, and as a result, the whole of the display unit 5 is in a white display condition.

In addition, if, after the termination of the above-described second frame F2, the whole of the display unit 5 is still in an insufficient white display condition, until realization of a sufficient white display condition of the whole of the display unit 5, operations performed during the first frame F1 and the second frame F2 are iteratively executed at a plurality of times.

In this embodiment, the pixel electrode 35A and the pixel electrode 35B that are located adjacent each other in the line direction are supplied with respective voltages, each having a polarity the same as that of an electric potential of the common electrode 37, and having the corresponding voltage levels, which are different from each other, relative to an electric potential level of the common electrode 37.

To date, there has been a disadvantage in that, in the case where, before reset processing is performed, certain two pixels, which are located adjacent each other in the line direction, are in a mutually different display condition, after performing the reset processing, a thin incidental image occurs at the boundary between the certain two pixels, one being caused to display a white color by changing a gray scale thereof, the other one being caused not to change a gray scale thereof (i.e., the other one being caused to maintain a white display condition thereof as it is); however, the above-described driving method according to this embodiment enables suppression of the occurrence of such an incidental image.

That is, in the above-described driving method according to this embodiment, by supplying the pixel electrode 35 corresponding to the first pixel 40A and the pixel electrode 35B corresponding to the second pixel 40B, the first pixel 40A and the second pixel 40B being located adjacent each other in the line direction, with respective voltages, each having a polarity the same as that of an electric potential of the common electrode 37, and having the corresponding voltage levels different from each other relative to an electric potential level of the common electrode 37, it is possible to generate an electric field between the pixel electrode 35A and the pixel electrode 35B that are located adjacent each other in the line direction. It can be inferred that, when the pixel electrodes 35A and 35B are driven by only an electric field extending in a vertical direction, the white-color particles and the black-color particles mutually block movements thereof; however, owing to an electric field extending in an oblique direction, particles existing at the boundary between the pixel electrodes 35A and the 35B are driven in the oblique direction, so that the particles are caused to move in a plurality of directions, and thereby, are allowed to move smoothly to a great extent. Owing to this operation, consequently, it is possible to erase images, concurrently with suppressing occurrences of incidental images thereof.

Furthermore, it is possible to shorten display response times of individual pixels, and as a result, it is possible to shorten a period of time necessary to execute white erasing reset processing, and thereby, reduce power consumption.

### Second Embodiment

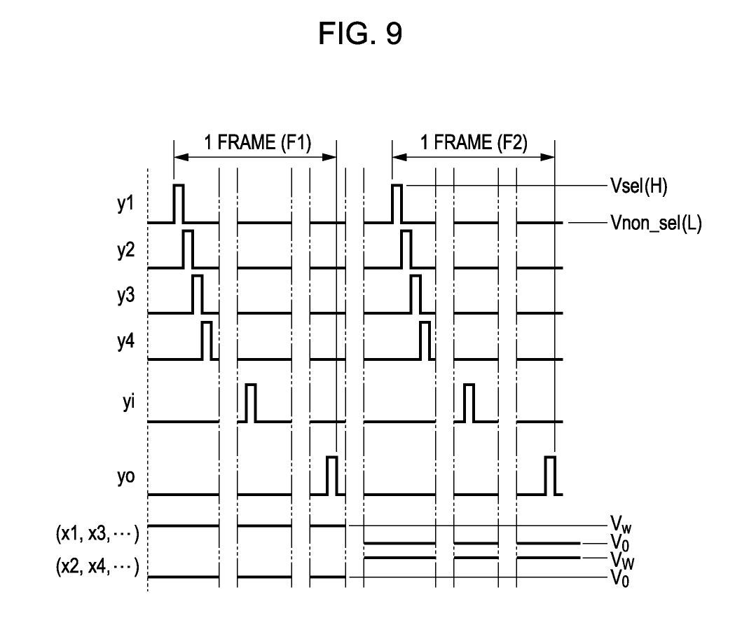

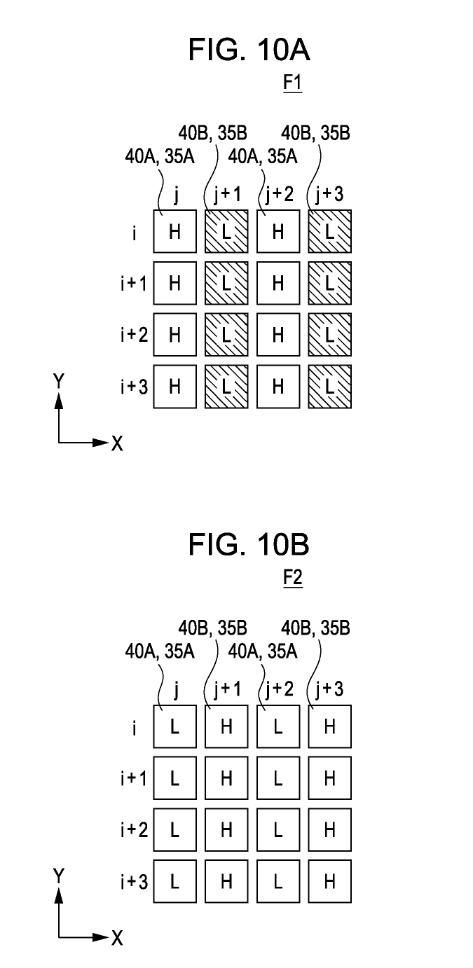

Next, a driving method for driving an electrophoretic display apparatus, according to a second embodiment of the invention, will be described below. FIG. 9 is a timing chart illustrating a driving method for driving an electrophoretic display apparatus, according to the second embodiment. Further, FIGS. 10A and 10B are diagrams illustrating condition changes of pixels targeted for explanation of a driving method according to the second embodiment.

In a first frame F1, as shown in FIG. 9, during a period of time while the selection voltage (Vsel) is supplied to each of the scanning lines 66 (y1, y2, . . . , yo), the first voltage (Vw) is supplied to each of odd numbered rows of the data lines 68 (x1, x3, . . . ), and the second voltage (V0) is supplied to each of even numbered rows of the data lines 68 (x2, x4, . . . ). In such a way as described above, as a result, the high-level (H) signals are inputted to the respective pixel electrodes 35A that are connected to each of odd numbered rows (j, j+2, . . . ), and the low-level (L) signals are inputted to the respective pixel electrodes 35B that are connected to each of even numbered rows (j+1, j+3, . . . ) (refer to FIG. 10A).

Subsequently, in the first frame F1, the electrophoretic components 32 are driven by an electric potential difference generated between each of the pixel electrodes 35A (high level) and the common electrode 37, and as shown in FIG. 10A, the first pixels 40A belonging to each of the odd numbered rows (j, j+2, . . . ) each commence to display a white color. In this case, an electric potential difference occurring between the pixel electrode 35A belonging to any one of the odd numbered rows (j, j+2, . . . ) and the pixel electrode 35B belonging to any one of the even numbered rows (j+1, j+3, . . . ) generates an electric field between the pixel electrode 35A and the pixel electrode 35B that are located adjacent each other in a row direction, and thereby, a plurality of the first pixels 40A belonging to each of the odd numbered rows (j, j+2, . . . ) each change a display condition thereof to a white display condition.

In a second frame F2, as shown in FIG. 9, during a period of time while the selection voltage (Vsel) is supplied to each of the scanning lines 66, the second voltage (V0) is supplied to each of the odd numbered rows of the data lines 68, and the first voltage (Vw) is supplied to each of the even numbered rows of the data lines 68. In such a way as described above, as a result, the low-level (L) signals are inputted to the respective pixel electrodes 35A that are connected to each of the odd numbered lines of the data lines 68, and the high-level (H) signals are inputted to the respective pixel electrodes 35B that are connected to each of the even numbered lines of the data lines 68.

Subsequently, in the second frame F2, the electrophoretic components 32 are driven by an electric potential difference generated between each of the pixel electrodes 35B (high level) and the common electrode 37, and as shown in FIG. 10B, this time, the second pixels 40B belonging to each of the even numbered rows (j+1, j+3, . . . ) each commence to display a white color. In this case, an electric potential difference occurring between the pixel electrode 35A corresponding to any one of the odd numbered rows (j, j+2, . . . ) and the pixel electrode 35B corresponding to any one of the even numbered rows (j+1, j+3, . . . ), generates an electric field between the pixel electrode 35A and the pixel electrode 35B that are located adjacent each other in the row direction, and thereby, the second pixels 40B belonging to each of the even numbered rows (j+1, j+3, . . . ) each change a display condition thereof to a white display condition.

Therefore, an electric potential difference occurring between the pixel electrode 35A and the pixel electrode 35B, which correspond to the first pixel 40A and the second pixel 40B that are located adjacent each other in the row direction, respectively, generates an electric field between the electrode 35A and the electrode 35B, and as a result, it is possible to obtain effects just like those of the above-described first embodiment. Further, in the driving method according to this embodiment, since the number of voltage level changes of the data lines 66 can be reduced to an extent more than in the case of the driving method according to the first embodiment, it is possible to reduce power consumption due to parasitic capacities of the data lines 68.

### Third Embodiment

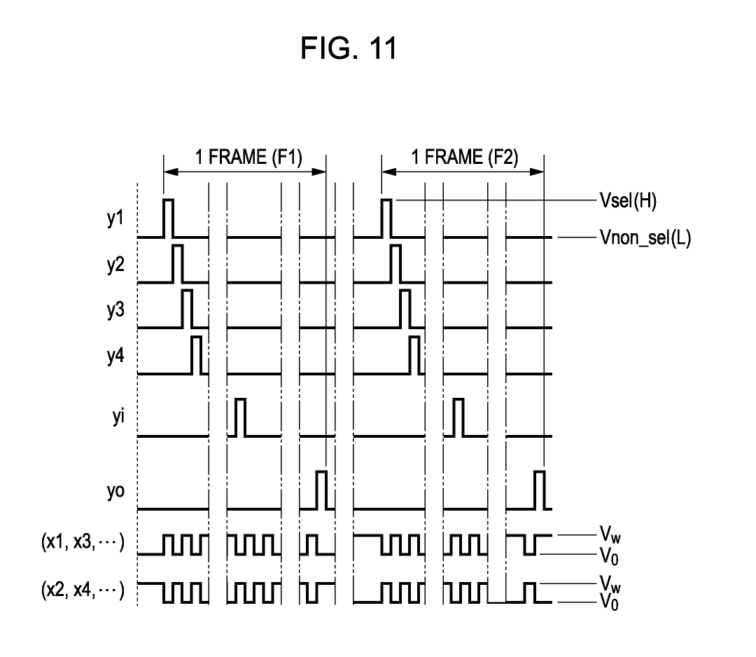

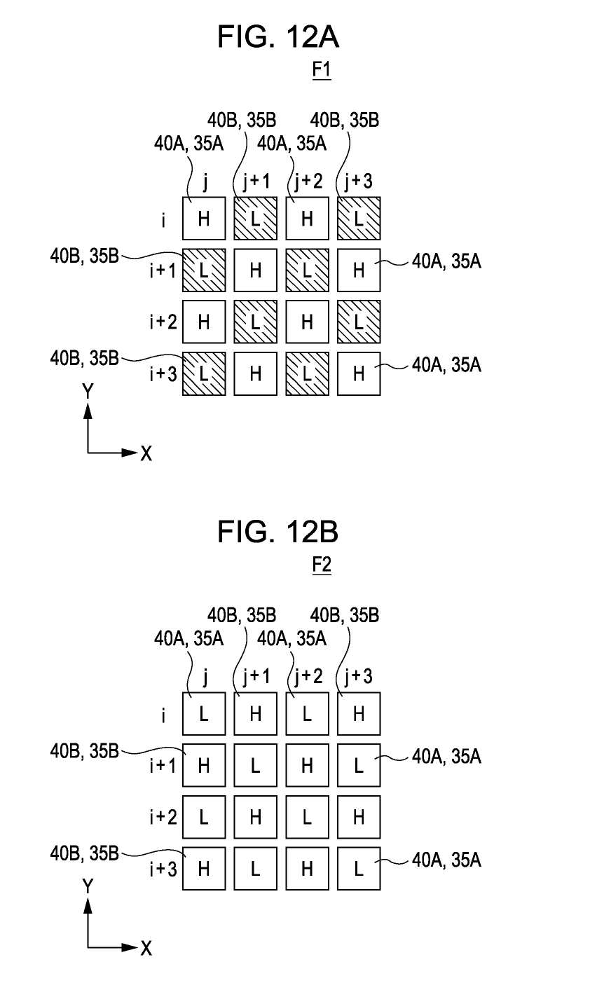

Next, a driving method for driving an electrophoretic display apparatus, according to a third embodiment of the invention, will be described below. FIG. 11 is a timing chart illustrating a driving method for driving an electrophoretic display apparatus, according to the third embodiment. Further, FIGS. 12A and 12B are diagrams illustrating condition changes of pixels targeted for explanation of a driving method according to the third embodiment.

In a first frame F1, as shown in FIG. 11, in synchronization with operations of sequentially selecting the scanning lines 66, performed by the scanning line driving circuit 61, during a period of time while each of odd numbered lines of the scanning lines 66 (y1, y3, . . . ) is selected, the first voltage (Vw) is supplied to each of odd numbered rows of the data lines 68 (x1, x3, . . . ) and the second voltage (V0) is supplied to each of even numbered rows of the data lines 68 (x2, x4, . . . ). Further, during a period of time while each of even numbered lines of the scanning lines 66 (y2, y4, . . . ) is selected, the second voltage (V0) is supplied to each of the odd numbered rows of the data lines 68, and the first voltage (Vw) is supplied to each of the even numbered rows of the data lines 68. The pulse width of each of rectangular pulses that are supplied to the respective data lines 68 in synchronization with the selection of a certain line of the scanning lines 66 is set in accordance with a duration in which the certain line of the scanning lines 66 is selected.

In such a way described above, as shown in FIG. 12A, the high-level (H) signals are inputted to the pixel electrodes 35A corresponding to the respective intersections of odd numbered lines (i, i+2, . . . ) and odd numbered rows (j, j+2, . . . ), and the pixel electrodes 35A corresponding to the respective intersections of even numbered lines (i+1, i+3, . . . ) and even numbered rows (j+1, j+3, . . . ). Further, the low-level (L) signals are inputted to the pixel electrodes 35B corresponding to the respective intersections of the odd numbered lines (i, i+2, . . . ) and the even numbered rows (j+1, j+3, . . . ), and the pixel electrodes 35B corresponding to the respective intersections of the odd numbered rows (j, j+2, . . . ) and the even numbered lines (i+1, i+3, . . . ).

Subsequently, in the first frame F1, the first pixels 40A corresponding to the respective intersections of the odd numbered lines and the odd numbered rows, as well as the first pixels 40A corresponding to the respective intersections of the even numbered lines and the even numbered rows, each change a display condition thereof to a white display condition; while the second pixels 40B corresponding to the respective intersections of the odd numbered lines and the even numbered rows, as well as the second pixels 40B corresponding to the respective intersections of the odd numbered rows and the even numbered lines, each maintain a black display condition thereof as it is. In such a way, as a result, all the first pixels 40A of the display unit 5 each display a white color in a checkered pattern.

In a second frame, as shown in FIG. 11, in synchronization with operations of sequentially selecting the scanning lines 66, performed by the scanning line driving circuit 61, during a period of time while the selection voltage (Vsel) is supplied to each of odd numbered lines of the scanning lines 66, the second voltage (V0) is supplied to each of the odd numbered rows of the data lines 68, and the first voltage (Vw) is supplied to each of the even numbered rows of the data lines 68. Further, during a period of time while the selection voltage (Vsel) is supplied to each of the even numbered lines of the scanning lines 66, the first voltage (Vw) is supplied to each of the odd numbered rows of the data lines 68, and the second voltage (Vo) is supplied to each of the even numbered rows of the data lines 68.

In such a way as described above, as shown in FIG. 12B, as a result, the low-level (L) signals are inputted to the pixel electrodes 35A corresponding to the respective intersections of the odd numbered lines and the odd numbered rows, and the pixel electrodes 35B corresponding to the respective intersections of the even numbered lines and the even numbered rows, and the high-level signals (H) are inputted to the pixel electrodes 35B corresponding to the respective intersections of the odd numbered lines and the even numbered rows, and the pixel electrodes 35A corresponding to the respective intersections of the even numbered lines and the odd numbered rows.

Subsequently, in the second frame F2, the second pixels 40B corresponding to the respective intersections of the even numbered lines and the odd numbered rows, as well as the second pixels 40B corresponding to the respective intersections of the odd numbered lines and the even numbered rows, each change a display condition thereof to a white display condition; while the first pixels 40A corresponding to the respective intersections of the odd numbered lines and the odd numbered rows, as well as the first pixels 40A corresponding to the respective intersections of the even numbered lines and the even numbered rows, each remain to maintain a white display condition, to which, in the first frame F1, each of the first pixels 40A changed a display condition thereof.

In such a way as described above, as a result, the whole of the display unit 5 is in a white display condition.

In such a way as described, supplying voltages, voltage levels of which are different from each other, to the pixel electrode 35A and the pixel electrode 35B, which correspond to the first pixel 40A and the second pixel 40B, that are located adjacent each other in the line direction, respectively, and the pixel electrode 35A and the pixel electrode 35B, which correspond to the first pixel 40A and the second pixel 40B that are located adjacent each other in the row direction, respectively, generates an electric field between the pixel electrode 35A and the pixel electrode 35B that are located adjacent each other in the line direction, as well as an electric field between the pixel electrode 35A and the pixel electrode 35B that are located adjacent each other in the row direction, and, as a result, it is possible to obtain effects just like those of the above-described embodiments.

When a pixel electrode 35 corresponding to a certain pixel 40 is supplied with the first voltage (Vw), supplying the first voltage (Vw) to the pixel electrodes 35 corresponding to the respective pixels 40, which are located in oblique directions relative to respective four directions, which are an upper direction, a lower direction (these directions being along the line direction), a left direction and a right direction (these being along the row direction) relative to the certain pixel 40, that is, as shown in FIGS. 12A and 12B, supplying the first voltage (Vw) to the pixel electrodes 35 (35A) corresponding to the respective four pixels 40 (40A), which are located at the four corners of the certain pixel 40 (40A), respectively, generates an electric potential difference between any two of the pixel electrodes 35 that are located adjacent each other.

In this embodiment, electric fields occur in the directions away from and towards the respective four sides of each of the pixel electrodes 35A (35B) occur, and thus, when white display reset processing on the display unit 5 having a certain black display image displayed thereon is performed, the electric fields enable white-color particles and black-color particles to move efficiently, and as a result, it is possible to increase an effect of suppression of occurrences of incidental images at the boundary between the black display image targeted for erasure and a background thereof.

### Fourth Embodiment

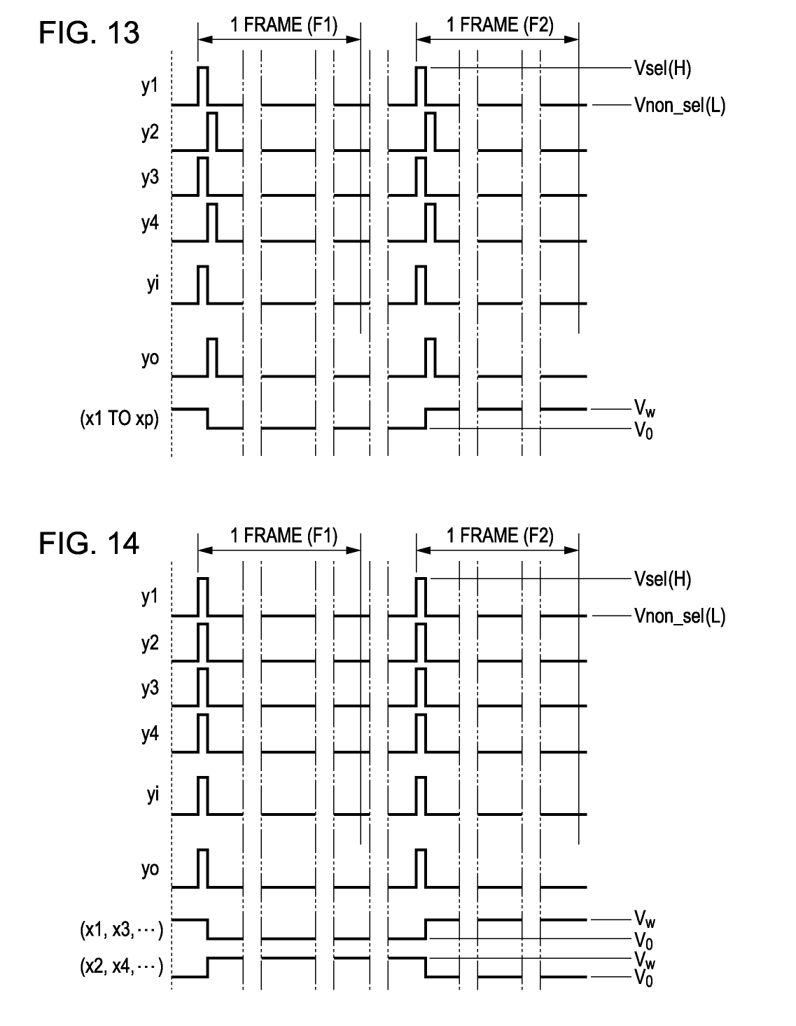

Next, a driving method for driving an electrophoretic display apparatus, according to a fourth embodiment of the invention, will be described below. FIG. 13 is a timing chart illustrating a driving method for driving an electrophoretic display apparatus, according to the fourth embodiment.

In each of the above-described embodiments, the scanning lines 66 are sequentially selected by the scanning line driving circuit 61 on a line-by-line basis, but, in this embodiment, the scanning lines 66 are collectively selected as two groups of the scanning lines 66, one group including a plurality of odd numbered lines of the scanning lines 66, the other group including a plurality of even numbered lines of the scanning lines 66, and thereby, it is intended to realize shortening of a period of time of one frame (a vertical scanning period of time).

In a first frame F1, firstly, as shown in FIG. 13, during a period of time while a plurality of odd numbered lines of the scanning lines 66 (y1, y3, . . . ), which are included in the display unit 5, are simultaneously selected, all the data lines 68 (x1, x2, . . . xp) are supplied with the first voltage (Vw). Subsequently, during a period of time while a plurality of even numbered lines of the scanning lines 66 (y2, y4, . . . ) are simultaneously selected, all the data lines 68 (x1, x2, . . . xp) are supplied with the second voltage (V0). Consequently, all the first pixels 40A included in the display unit 5, which belong to each of the odd numbered lines, each change a display condition thereof to a white display condition at once (refer to FIG. 8B). In contrast, all the second pixels 40B included in the display unit 5, which belong to each of the even numbered lines, each maintain a black display condition thereof as it is.

In a second frame F2, during a period of time while a plurality of the odd numbered lines of the scanning lines 66 are simultaneously selected, all the data lines 68 are supplied with the second voltage (V0). Subsequently, during a period of time while a plurality of the even numbered lines of the scanning lines 66 are simultaneously selected, all the data lines 68 are supplied with the first voltage (Vw). Consequently, all the second pixels 40B included in the display unit 5, which belong to each of the even numbered lines, each change a display condition thereof to a white display condition at once (refer to FIG. 8C). In such a way as described above, the whole of the display unit 5 is in a white display condition. Therefore, between the pixel electrode 35A corresponding to the pixel 40A and the pixel electrode 35B corresponding to the pixel 40B, the pixel 40A and the pixel 40B being located adjacent each other in the line direction, an electric potential difference is generated, thus, an electric field occurs owing to the electric potential difference, and as a result, it is possible to obtain effects just like those of the above-described embodiments.

In such a way as described above, by selecting the scanning lines 66 simultaneously and collectively as two groups of the scanning lines 66, one group including a plurality of the odd numbered lines thereof, the other group including a plurality of the even numbered lines thereof, the number of timings, at which the selection voltages are supplied to the respective scanning lines within a period of time of one frame, is reduced to only two, and thus, it is possible to shorten a period of time of one frame to a great extent. Further, since the number of voltage-level changes for each of the data lines 68 is reduced, it is possible to reduce power consumption due to parasitic capacities of the data lines 68.

Further, since two conditions can be promptly changed, it is possible to suppress occurrences of incidental images more effectively. Here, it is not necessary to supply selection voltages to all the respective scanning lines 66 in each frame, but, for example, in the case where the number of the scanning lines is 480, the above-described driving operations may be performed for each of four groups, which includes 120 scanning lines resulting from dividing the 480 scanning lines by four. In this way, since the number of simultaneously selected lines is reduced, it is possible to suppress increasing of an amount of electric currents flown into the display system 2, and thus, it is possible to simplify configuration of a power supply included in the electrophoretic display apparatus 1.

In addition, in the first frame F1, as well as in the second frame F2, the selection of the scanning lines 66 may be preceded by either of a group of odd numbered lines or a group of even numbered lines.

### Fifth Embodiment

Next, a driving method for driving an electrophoretic display apparatus, according to a fifth embodiment of the invention, will be described below. FIG. 14 is a timing chart illustrating a driving method for driving an electrophoretic display apparatus, according to the fifth embodiment.

In a first frame F1, as shown in FIG. 14, during a period of time while all the scanning lines 66 (y1, y2, . . . yo) are simultaneously selected by the scanning line driving circuit 61, odd numbered rows of the data lines 68 (x1, x3, . . . ) are supplied with the first voltage (Vw), and even numbered rows of the data lines 68 (x2, x4, . . . ) are supplied with the second voltage (V0).

As a result of this operation, in the first frame F1, all the first pixels 40A belonging to each of a plurality of odd numbered rows each change a display condition thereof to a white display condition at once. A display condition of the display unit 5 immediately after the first frame has terminated is just like that shown in FIG. 10A.

In a second frame F2, during a period of time while all the scanning lines 66 (y1, y2, . . . yo) are simultaneously selected by the scanning line driving circuit 61, the odd numbered rows of the data lines 68 are supplied with the second voltage (V0), and the even numbered rows of the data lines 68 are supplied with the first voltage (Vw). As a result of this operation, in the second frame F2, all the second pixels 40B belonging to each of the plurality of even numbered rows each change a display condition thereof to a white display condition at once. A display condition of the display unit 5 immediately after the second frame has terminated is just like that shown in FIG. 10B.

In such a way as described above, as a result, the whole of the display unit 5 is in a white display condition.

In the above-described driving method according to this embodiment, during a period of time while all the scanning lines 66 are selected at once, by supplying a group of odd numbered rows of the data lines 68 and another group of even numbered rows of the data lines 68 with respective predetermined voltages, between the pixel electrode 35A corresponding to the pixel 40A and the pixel electrode 35B corresponding to the pixel 40B, the pixel 40A and the pixel 40B being located adjacent each other in the row direction, an electric potential difference is generated, thus, an electric field occurs owing to the electric potential difference, and as a result, it is possible to obtain effects just like those of the above-described embodiments.

Further, by selecting all the scanning lines at once, the number of voltage-level changes for each of the data lines 68 is reduced, and thus, it is possible to reduce power consumption due to parasitic capacities of the data lines 68. Further, it is also possible to shorten a processing time necessary to perform image erasing processing to a more extent. Consequently, this driving method is a more superior driving method for driving an electrophoretic apparatus in an electric power saving operation.

### Sixth Embodiment

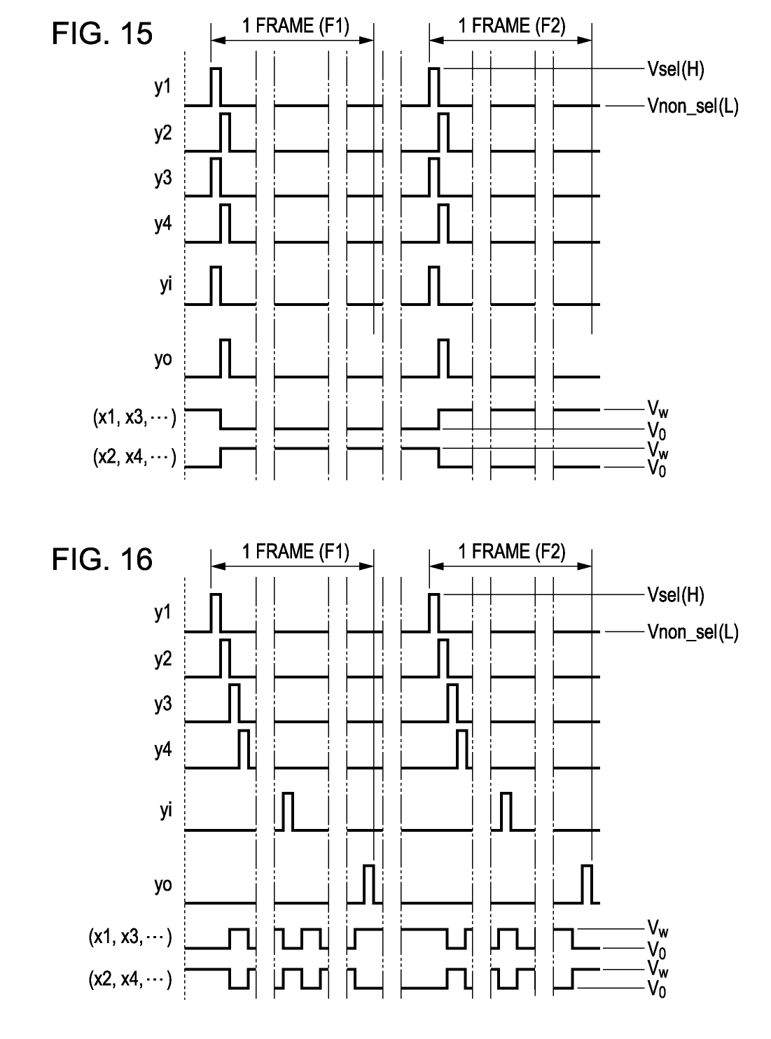

Next, a driving method for driving an electrophoretic display apparatus, according to a sixth embodiment of the invention, will be described below. FIG. 15 is a timing chart illustrating a driving method for driving an electrophoretic display apparatus, according to the sixth embodiment.

In a first frame F1, as shown in FIG. 15, during a period of time while a plurality of odd numbered scanning lines 66 (y1, y3, . . . ) are simultaneously selected by the scanning line driving circuit 61, odd numbered rows of the data lines 68 (x1, x3, . . . ) are supplied with the first voltage (Vw), and even numbered rows of the data lines 68 (x2, x4, . . . ) are supplied with the second voltage (V0). Subsequently, during a period of time while a plurality of even numbered scanning lines 66 (y2, y4, . . . ) are simultaneously selected, odd numbered rows of the data lines 68 (x1, x3, . . . ) are supplied with the second voltage (V0), and even numbered rows of the data lines 68 (x2, x4, . . . ) are supplied with the first voltage (Vw).

As a result of this operation, the first voltage (Vw) is supplied to the pixel electrodes 35A corresponding to the respective intersections of the odd numbered lines and the odd numbered rows and the pixel electrodes 35A corresponding to the respective intersections of the even numbered lines and the even numbered rows, and the second voltage (V0) is supplied to the pixel electrodes 35B corresponding to the respective intersections of the even numbered lines and the odd numbered rows and the pixel electrodes 35B corresponding to the respective intersections of the odd numbered lines and the even numbered rows. A display condition of the display unit 5 immediately after the first frame has terminated is just like that shown in FIG. 12A.

In a first frame F2, during a period of time while the odd numbered scanning lines 66 are simultaneously selected by the scanning line driving circuit 61, the odd numbered rows of the data lines 68 are supplied with the second voltage (V0), and the even numbered rows of the data lines 68 are supplied with the first voltage (Vw). Subsequently, during a period of time while the even numbered scanning lines 66 are simultaneously selected by the scanning line driving circuit 61, the odd numbered rows of the data lines 68 are supplied with the first voltage (Vw), and the even numbered rows of the data lines 68 are supplied with the second voltage (V0).

As a result of this operation, the second voltage (V0) is supplied to the pixel electrodes 35A corresponding to the respective intersections of the odd numbered lines and the odd numbered rows and the pixel electrodes 35A corresponding to the respective intersections of the even numbered lines and the even numbered rows, and the first voltage (Vw) is supplied to the pixel electrodes 35B corresponding to the respective intersections of the even numbered lines and the odd numbered rows and the pixel electrodes 35B corresponding to the respective intersections of the odd numbered lines and the even numbered rows. A display condition of the display unit 5 immediately after the second frame has terminated is just like that shown in FIG. 12B.

As described above, finally, the voltages of individual pixel electrodes in this embodiment are the same as those in the third embodiment, and thus, it is possible to obtain effects just like those of the third embodiment. Further, in the third embodiment, the scanning lines 66 are sequentially selected on a line-by-line basis; however, in this embodiment, a plurality of odd numbered scanning lines 66, as well as a plurality of even numbered scanning lines 66, are simultaneously selected, and thus, it is possible to reduce a period of time of one frame to an extent more than in the third embodiment.

In this embodiment, in a former frame, the first voltage (Vw) is supplied to each of the pixels 40 that are allocated in a one-pixel based checkered pattern, and the second voltage (V0) is supplied to each of the remaining pixels 40. Further, in a latter frame, the second voltage (V0) is supplied to each of the pixels 40 that were supplied with the first voltage (Vw) in the former frame, and the first voltage (Vw) is supplied to each of the pixels 40 that were supplied with the second voltage (V0) in the former frame. In this way, as a result, since electric fields occur in the directions away from and towards the respective four sides of each of the pixel 40, when white display reset processing on the display 5 having a certain black display image displayed thereon is performed, it is possible to increase an effect of suppression of occurrences of an incident image at the boundary between the black display image targeted for erasure and a background thereof.

### Seventh Embodiment

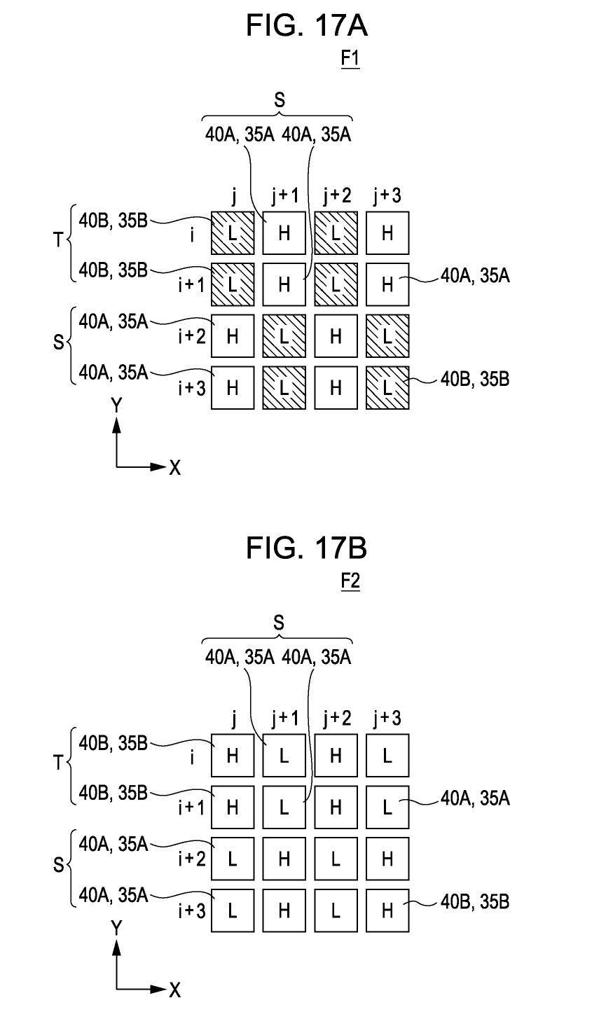

Next, a driving method for driving an electrophoretic display apparatus, according to a seventh embodiment of the invention, will be described below. FIG. 16 is a timing chart illustrating a driving method for driving an electrophoretic display apparatus, according to this embodiment. FIGS. 17A and 17B are diagrams illustrating condition changes of pixels targeted for explanation of a driving method according to this embodiment.

In this embodiment, the first voltage is supplied to each unit of handling pixels, which consists of two pixels corresponding to the respective intersections of two successive lines and one row, and is allocated in a checkered pattern.

In a first frame F1, the scanning lines 66 are sequentially selected by the scanning line driving circuit 61 on a line-by-line basis, and a predetermined image signal is inputted to each of the pixels 40 belonging to the selected scanning line 66. In this case, the same voltage pattern 1 consisting of the first voltage (Vw) and the second voltage (V0) is supplied to two groups of the pixels 40, which correspond to the respective two scanning lines 66 that are located adjacent each other in the line direction, and the same voltage pattern 2 consisting of the first voltage (Vw) and the second voltage (V0), which is different from the voltage pattern 1 that was supplied to the two groups of the pixels 40, which correspond to the respective two scanning lines 66 that were immediately previously selected, is supplied to next two groups of the pixels 40, which correspond to the respective following two scanning lines 66 that are located adjacent each other in the line direction.

More specifically, firstly, during a period of time while a line y1 of the scanning lines 66 is selected, odd numbered rows (x1, x3, . . . ) of the data lines 68 are supplied with the second voltage (V0), and even numbered rows (x2, x4, . . . ) of the data lines 68 are supplied with the first voltage (Vw). Subsequently, during a period of time while a line y2 of the scanning lines 66 is selected, the odd numbered rows of the data lines 68 are supplied with the second voltage (V0), and the even numbered rows of the data lines 68 are supplied with the first voltage (Vw).

Subsequently, during a period of time while a line y3 of the scanning lines 66 is selected, the odd numbered rows of the data lines 68 are supplied with the first voltage (Vw), and the even numbered rows of the data lines 68 are supplied with the second voltage (V0). Subsequently, during a period of time while a line y4 of the scanning lines 66 is selected, the odd numbered rows of the data lines 68 are supplied with the first voltage (Vw), and the even numbered rows of the data lines 68 are supplied with the second voltage (V0).

Although omitted from illustration, during each of a line y5 (omitted from illustration) and a line y6 (omitted from illustration) of the scanning lines 66 is selected, just like each of the cases of the line y1 and the line y2 of the scanning lines 66, the second voltage (V0) is supplied to the odd numbered rows of the data lines 68, and the first voltage (Vw) is supplied to the even numbered rows of the data lines 68.

Further, during each of a line y7 (omitted from illustration) and a line y8 (omitted from illustration) of the scanning lines 66 is selected, just like each of the cases of the line y3 and the line y4 of the scanning lines 66, the first voltage (Vw) is supplied to the odd numbered rows of the data lines 68, and the second voltage (V0) is supplied to the even numbered rows of the data lines 68.

Subsequently thereto, processing, in which the same predetermined voltage pattern 1 consisting of the first voltage (Vw) and the second voltage (V0), which is different from the same voltage pattern 2 that was supplied to two groups of the pixels 40, corresponding to the respective two scanning lines 66 that were immediately previously selected, is supplied to next two groups of the pixels 40, corresponding to the respective following two scanning lines 66, is iteratively and periodically performed.

In such a way as described above, as shown in FIG. 17A, the first voltage (Vw) is supplied to each cluster S of the first pixels, that is, the first voltage (Vw) is supplied to each unit of handling pixels, which is allocated in a checkered pattern, and consists of the two pixel electrodes 35A corresponding to the respective intersections of two successive lines and one row, and forming each cluster S of the first pixels, and the second voltage (V0) is supplied to each remaining unit of handling pixels, which consists of the pixel electrodes 35B forming each cluster T of the second pixels.

In a frame F2, the first voltage (Vw) is supplied to the pixels 40 each having not been caused to be in a white display condition in the first frame F1. During a period of time while each of the line y1 and the line y2 of the scanning lines 66 is selected, the first voltage (Vw) is supplied to the odd numbered rows of the data lines 68, and the second voltage (V0) is supplied to the even numbered rows of the data lines 68. Subsequently, during a period of time while each of the line y3 and the line y4 of the scanning lines 66 is selected, the second voltage (V0) is supplied to the odd numbered rows of the data lines 68, and the first voltage (Vw) is supplied to the even numbered rows of the data lines 68.

Subsequently, during a period of time while each of the line y5 and the line y6 of the scanning lines 66 is selected, the first voltage (Vw) is supplied to the odd numbered rows of the data lines 68, and the second voltage (V0) is supplied to the even numbered rows of the data lines 68.

Subsequently thereto, processing, in which the same voltage pattern 1 consisting of the first voltage (Vw) and the second voltage (V0), which is different from the same voltage pattern 2 that was supplied to two groups of the pixels 40, corresponding to the respective two scanning lines 66 that were immediately previously selected, is supplied to next two groups of the pixels 40, corresponding to the respective following two scanning lines 66, is iteratively and periodically performed.

In such a way as described above, as shown in FIG. 17B, the first voltage (Vw) is supplied to each cluster T of the second pixels, that is, the first voltage (Vw) is supplied to each unit of handling pixels, which is allocated in a checkered pattern, and consists of the pixel electrodes 35B corresponding to the respective intersections of two successive lines and one row, and forming each cluster T of the second pixels, and the second voltage (V0) is supplied to each remaining unit of handling pixels, which consist of the pixel electrodes 35A forming each cluster S of the first pixels.

As a result of such an operation, an electric potential difference occurs between the pixel electrode 35A and the pixel electrode 35B that are located adjacent each other in the row direction, and concurrently therewith, an electric field occurs between the pixel electrode 35A and the pixel electrode 35B, which are supplied with respective voltages that are different from each other, such as between the pixel electrode 35A belonging to the line y2 (for example, an (i+1)th line) and the pixel electrode 35B belonging to the line y3 (for example, an (i+2)th line), between the pixel electrode 35A belonging to the line y4 and the pixel electrode 35B belonging to the line y5, and as a result, the pixels 40, which are supplied with the high-level (H) signal, each change a display condition thereof to a white display condition.

In the above-described driving method according to this embodiment, processing is performed so that the same voltage pattern is supplied to two groups of the pixels 40, which correspond to the respective two successive scanning lines 66, so that the number of voltage-level changes for each of the data lines 68 is reduced, and thus, it is possible to reduce power consumption due to parasitic capacities of the data lines 68.

### Eighth Embodiment

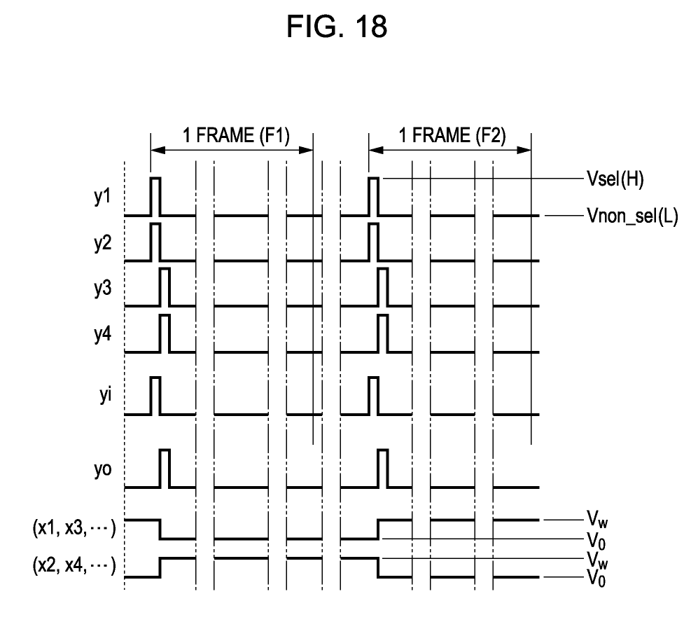

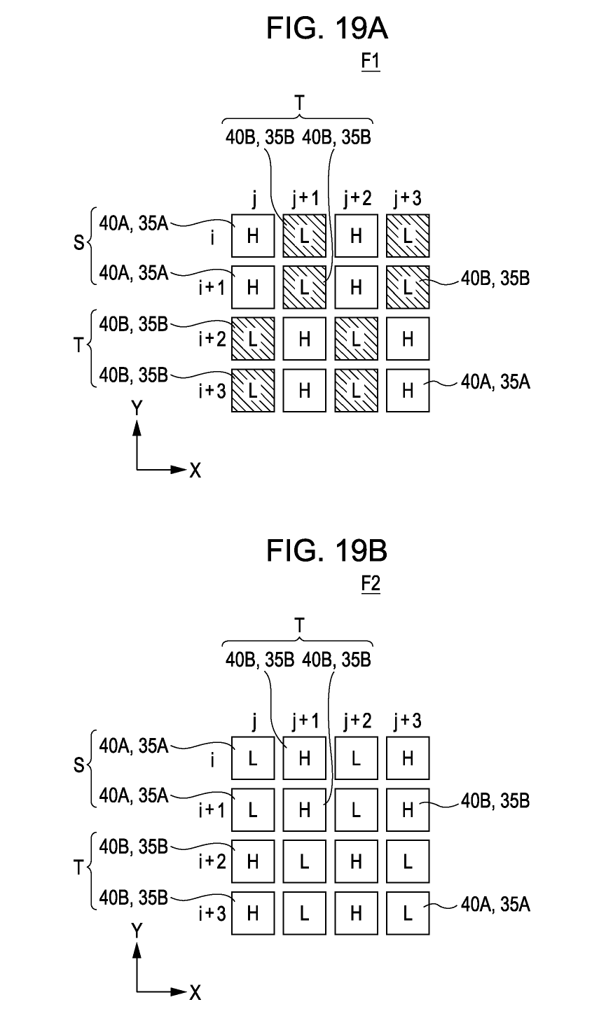

Next, a driving method for driving an electrophoretic display apparatus, according to an eighth embodiment of the invention, will be described below. FIG. 18 is a timing chart illustrating a driving method for driving an electrophoretic display apparatus, according to this embodiment. FIGS. 19A and 19B are diagrams illustrating condition changes of pixels targeted for explanation of a driving method according to this embodiment.

In this embodiment as well, the first voltage is supplied to each unit of handling pixels, which consists of two pixels corresponding to the respective intersections of successive two lines and one row, and is allocated in a checkered pattern.

In this embodiment, a plurality of groups each consisting of two successive scanning lines 66 and being allocated at intervals of three scanning lines are simultaneously selected.

In a first frame F1, firstly, during a period of time while a plurality of groups each consisting of two successive scanning lines 66, that is, a group of a line y1 and a line y2, a group of a line y5 (omitted from illustration) and a line y6 (omitted from illustration), . . . , are simultaneously selected, odd numbered rows of the data lines 68 (x1, x3, . . . ) are supplied with the first voltage (Vw), and even numbered rows of the data lines 68 (x2, x4, . . . ) are supplied with the second voltage (V0).

Subsequently, during a period of time while a plurality of groups each consisting of the two successive scanning lines 66, that is, a group of a line y3 and a line y4, a group of a line y7 (omitted from illustration) and a line y8 (omitted from illustration), . . . , are simultaneously selected, the odd numbered rows of the data lines 68 are supplied with the second voltage (V0), and the even numbered rows of the data lines 68 are supplied with the first voltage (Vw).

In such a way as described above, as shown in FIG. 19A, the first voltage (Vw) is supplied to each cluster S of the first pixels, that is, the first voltage (Vw) is supplied to each unit of handling pixels, which consists of the pixel electrodes 35A corresponding to the respective intersections of two successive lines and one row, and forming each cluster S of the first pixels, and the second voltage (V0) is supplied to each unit of handling pixels, which consists of the pixel electrodes 35B corresponding to the respective intersections of two successive lines and one row, and forming each cluster T of the second pixels. In such a way as described above, each unit of handling pixels, which forms the group S of the first pixels and is allocated in a checkered pattern, is in a white display condition.

In a second frame F1, firstly, during a period of time while a plurality of groups each consisting of the two successive scanning lines 66, that is, a group of a line y1 and a line y2, a group of a line y5 and a line y6, . . . , are simultaneously selected, the odd numbered rows of the data lines 68 are supplied with the second voltage (V0), and the even numbered rows of the data lines 68 are supplied with the first voltage (Vw).

Subsequently, during a period of time while a plurality of groups each consisting of the two successive scanning lines 66, that is, a group of a line y3 and a line y4, a group of a line y7 and a line y8, . . . , are simultaneously selected, the odd numbered rows of the data lines 68 are supplied with the first voltage (Vw), and the even numbered rows of the data lines 68 are supplied with the second voltage (V0).

Subsequently, the same scanning processing as that described above is periodically and iteratively performed for each group of the two scanning lines 66.

In such a way as described above, as shown in FIG. 19B, the first voltage (Vw) is supplied to each cluster T of the second pixels, that is, the first voltage (Vw) is supplied to each unit of handling pixels, which consists of the pixel electrodes 35B corresponding to the respective intersections of two successive lines and one row, and forming each cluster S of the second pixels and, and the second voltage (V0) is supplied to each unit of handling pixels, which consists of the pixel electrodes 35A corresponding to the respective intersections of two successive lines and one row, and forming each cluster S of the first pixels. In such a way as described above, each unit of handling pixels, which consist of two pixels forming the group T of the second pixels, and is allocated in a checkered pattern, changes a display condition thereof to a white display condition, and as a result, the whole of the display unit 5 is in a white display condition.

In the driving method according to this embodiment, in the first frame F1, through two selection processes, a first selection process being a process in which groups of the scanning lines 66, each group consisting of two successive scanning lines 66 and being located at intervals of three scanning lines, are simultaneously selected, a second selection process being a process in which groups of the scanning lines 66, having not been selected in the first process, are simultaneously selected, the first voltage (Vw) is supplied to each unit of handling pixels, which consists of two pixels corresponding to the respective intersections of successive two lines and one row, and is located in a checkered pattern, and the second voltage (V0) is supplied to pixels other than the pixels having been supplied with the first voltage (Vw). Further, in the second frame F2, through two processes the same as those of the first frame 1, the first voltage (Vw) and the second voltage (V0) are supplied to pixels having been supplied with the second voltage (V0) in the first frame F1 and pixels having been supplied with the first voltage (Vw) in the first frame, respectively. Therefore, it is possible to shorten a period of time of one frame to a great extent. Further, for each group of two successive scanning lines, the same predetermined voltage pattern is simultaneously supplied to two groups of data lines corresponding to the respective two successive scanning lines, therefore, it is possible to reduce the number of voltage changes of the data lines 68 to an extent more than the case of the driving method according to the seventh embodiment, and thus, it is possible to reduce power consumption due to parasitic capacities of the data lines 68.

Hereinbefore, preferred embodiments according to the invention have been described with reference to accompanying drawings, and needless to say, the invention is not limited to such embodiments. Obviously, those skilled in the art can conceive various changes or modifications of the invention within the scope of technical thoughts set forth in the appended claims, and naturally, it should be understood that such changes or modifications are included in the technical scope of the invention.

In addition, hereinbefore, the embodiments have been described by way of examples, in each of which the display unit 5 is a display unit adopting an active matrix method in which the scanning line driving circuit 61 and the data line driving circuit 62 are included, but, the display unit 5 may be a display unit adopting a segment driving method.

### Electronic Device

Next, cases, in each of which the above-described electrophoretic display apparatus 1 is applied to an electronic device, will be described below.

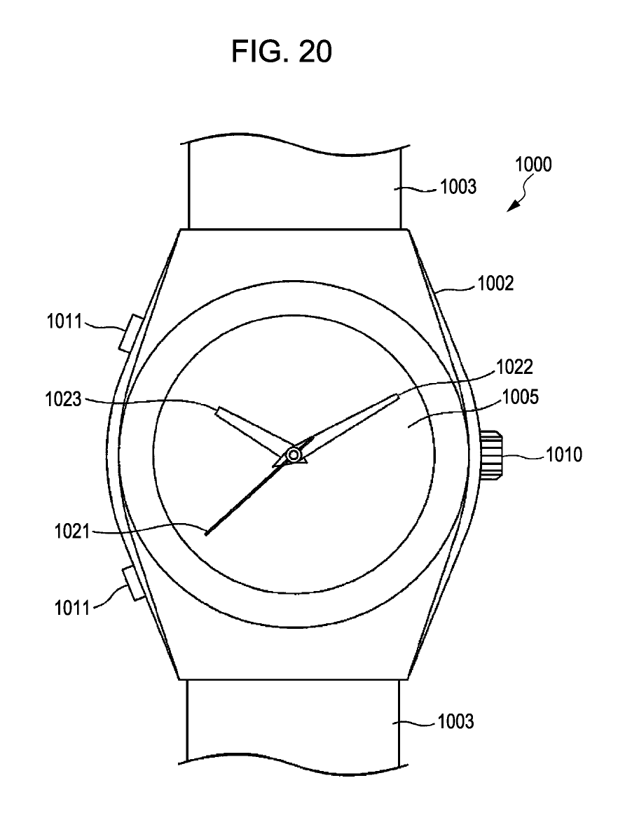

FIG. 20 is a diagram illustrating a front view of a wrist watch (an electronic device) 1000. The wrist watch 1000 includes a watch case 1002 and a pair of bands combined with the watch case 1002.

At the front surface of the watch case 1002, a display unit 1005 including an electrophoretic display apparatus according to the above-described embodiments, a second hand 1021, a minute hand 1022 and a hour hand 1023 are provided.

At the lateral side of the watch case 1002, a winding crown 1010 and an operation button 1011, each functioning as an operation unit, are provided. The winding crown 1010 is combined with a winding stem (omitted from illustration), which is provided inside the case, and is configured to be capable of being arbitrarily pushed and pulled at multi-stages (for example, two stages), and further, being arbitrarily rotated in conjunction with the winding stem. The display unit 1005 is capable of displaying thereon an image functioning as a background, a character stream of a date, a clock time and the like, a second hand, a minute hand, a hour hand and the like.

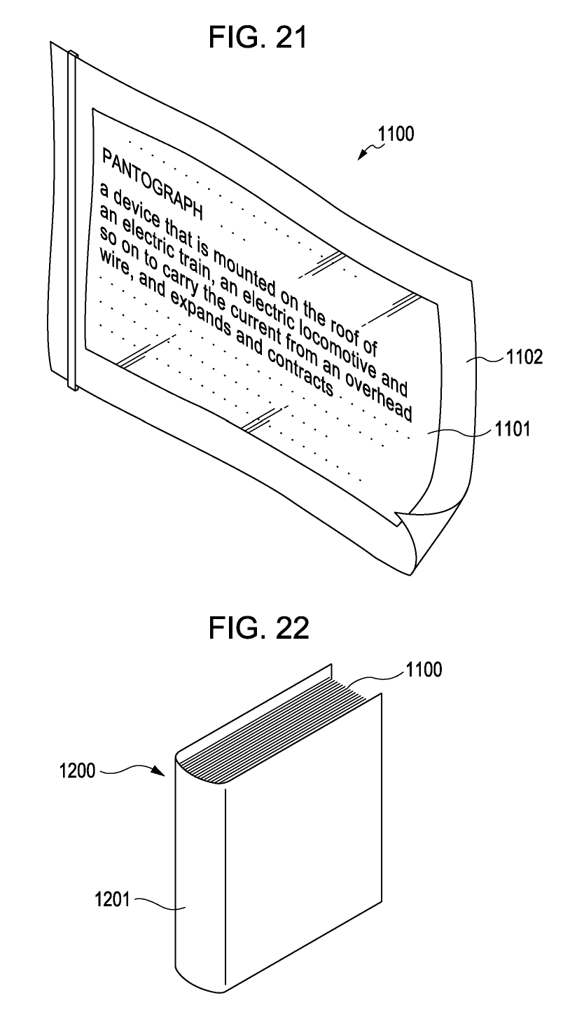

FIG. 21 is a perspective view illustrating the structure of an electronic paper 1100 (an electronic device).

The electronic paper 1100 includes the electrophoretic display apparatus according to either of the above-descried embodiments in a display unit 1101. The electronic paper 1100 has a flexibility and is configured to include a body 1102 having rewritable sheets therein, each having a texture and a softness just like those of a normal paper.

FIG. 22 is a perspective view illustrating the structure of an electronic notebook (an electronic device) 1200. The electronic notebook 1200 is a notebook in which a plurality of the above-described electronic papers 1100 are bundled, and further, is bound by a cover 1201. The cover 1201 includes, for example, a display data inputting unit (which is omitted from illustration) for inputting display data sent from external apparatuses. By using this display data inputting unit, it is possible to change or update display contents in accordance with the inputted display data under the condition where the electronic papers remain bundled.

The wrist watch 1000, the electronic paper 1100 and the electronic notebook 1200, having been described above, each adopt an electrophoretic display apparatus according to the invention, and thus, result in being an electrical device provided with a display method, which enables realization of a multi-grayscale display function on a compact and simple configuration.

In addition, the above-described electronic devices are just examples of an electronic device according to the invention, and the technical scope of the invention is not limited to the examples thereof. For example, it is also possible to appropriately apply an electrophoretic display apparatus according to the invention to a display unit included in individual electronic devices, such as mobile phones and portable audio devices.

The entire disclosure of Japanese Patent Application No. 2009-259845, filed Nov. 13, 2009 is expressly incorporated by reference herein.

What is claimed is:

1. A driving method for driving an electrophoretic display apparatus provided with a display unit, which is configured to include a pair of substrates having electrophoretic components interposed therebetween, a plurality of pixels that are disposed in a line direction and in a row direction, a plurality of pixel electrodes, each of the plurality of pixel electrodes being provided so as to correspond to one of the plurality of pixels, and an opposite electrode that is provided so as to be opposite the plurality of pixel electrodes, the driving method comprising:
a process which, when erasing an image displayed on the display unit, allows one of the plurality of pixel electrodes, which corresponds to a first pixel selected from among the plurality of pixels, and one of the plurality of pixel electrodes, which corresponds to a second pixel selected from among the plurality of pixels, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.

2. The driving method for driving an electrophoretic display apparatus, according to claim 1, the driving method further comprising:
a first process of supplying a first voltage to the pixel electrode corresponding to the first pixel, and supplying a second voltage, which is different from the first voltage, to the pixel electrode corresponding to the second pixel, and
a second process of supplying the second voltage to the pixel electrode corresponding to the first pixel, and supplying the first voltage to the pixel electrode corresponding to the second pixel.

3. The driving method for driving an electrophoretic display apparatus, according to claim 1, wherein the first pixel is a pixel belonging to an odd numbered line of the plurality of pixels, and the second pixel is a pixel belonging to an even numbered line of the plurality of pixels.

4. The driving method for driving an electrophoretic display apparatus, according to claim 1, wherein the first pixel is a pixel belonging to an odd numbered row of the plurality of pixels, and the second pixel is a pixel belonging to an even numbered row of the plurality of pixels.

5. The driving method for driving an electrophoretic display apparatus, according to claim 2, wherein, in each of the first process and the second process, all of the pixel electrodes belonging to a line of the pixels are supplied with either of the first voltage or the second voltage.

6. The driving method for driving an electrophoretic display apparatus, according to claim 2, wherein, in each of the first process and the second process, all of the pixel electrodes belonging to a row of the pixels are supplied with either of the first voltage or the second voltage.

7. The driving method for driving an electrophoretic display apparatus, according to claim 1,
wherein a plurality of the first pixels include a pixel selected from among the plurality of pixels corresponding to respective intersections of odd numbered lines of the plurality of pixels and odd numbered rows of the plurality of pixels, and a pixel selected from among the plurality of pixels corresponding to respective intersections of even numbered lines of the plurality of pixels and even numbered rows of the plurality of pixels, and
wherein a plurality of the second pixels include a pixel selected from among the plurality of pixels corresponding to respective intersections of odd numbered lines of the plurality of pixels and even numbered rows of the plurality of pixels, and a pixel selected from among the plurality of pixels corresponding to respective intersections of even numbered lines of the plurality of pixels and odd numbered rows of the plurality of pixels.

8. The driving method for driving an electrophoretic display apparatus, according to claim 1,
wherein a plurality of the first pixels form a group of the first pixels that correspond to respective intersections of any two adjacent lines selected from among the lines of the plurality of pixels, and any one row selected from among the rows of the plurality of pixels, and
wherein a plurality of the second pixels form a group of the second pixels that correspond to respective intersections of any two adjacent lines selected from among the lines of the plurality of pixels and any one row selected from among the rows of the plurality of pixels, the group of the second pixels being located adjacent to the group of the first pixels in the line direction, and further, being located adjacent to the group of the first pixels in the row direction.

9. The driving method for driving an electrophoretic display apparatus, according to claim 2, wherein a series of the first process and the second process are iteratively performed at a plurality of times.

10. An electrophoretic display apparatus provided with a display unit, which is configured to include a pair of substrates having electrophoretic components interposed therebetween, a plurality of pixels that are disposed in a line direction and in a row direction, a plurality of pixel electrodes, each of the plurality of pixel electrodes being provided so as to correspond to one of the plurality of pixels, and an opposite electrode that is provided so as to be opposite the plurality of pixel electrodes, the electrophoretic apparatus comprising:
a control unit configured to, when erasing an image displayed on the display unit, allows one of the plurality of pixel electrodes, which corresponds to a first pixel selected from among the plurality of pixels, and one of the plurality of pixel electrodes, which corresponds to a second pixel selected from among the plurality of pixels, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.

11. An electronic device including an electrophoretic display apparatus set forth in claim 10.

12. A controller for an electrophoretic display apparatus provided with a display unit, which is configured to include a pair of substrates having electrophoretic components interposed therebetween, a plurality of pixels that are disposed in a line direction and in a row direction, a plurality of pixel electrodes, each of the plurality of pixel electrodes being provided so as to correspond to one of the plurality of pixels, and an opposite electrode that is provided so as to be opposite the plurality of pixel electrodes, wherein
the controller configured to, when erasing an image displayed on the display unit, allows one of the plurality of pixel electrodes, which corresponds to a first pixel selected from among the plurality of pixels, and one of the plurality of pixel electrodes, which corresponds to a second pixel selected from among the plurality of pixels, the first pixel and the second pixel being located adjacent each other, to be supplied with respective voltages having corresponding polarities thereof the same as a polarity of an electric potential of the opposite electrode, and having corresponding voltage levels thereof different from each other relative to a level of the electric potential of the opposite electrode.
